(19) United States
(12) Patent Application Publication
(10) Pub. No.: US 2021/0350418 A1
(43) Pub. Date: Nov. 11, 2021

(54) METHOD AND APPARATUS FOR MANAGING DEALS OF BROKERS IN ELECTRONIC ADVERTISING

(71) Applicant: Xandr Inc., New York, NY (US)

(72) Inventors: Benjamin Kneen, New York, NY (US); Joshua Turner, Redondo Beach, CA (US); Jaidev Sridhar, New York, NY (US)

(73) Assignee: Xandr Inc., New York, NY (US)

(21) Appl. No.: 16/870,098

(22) Filed: May 8, 2020

(51) Int. Cl. G06Q 30/02

(52) U.S. Cl. CPC G06Q 30/0275; G06Q 30/0272; G06Q 30/0201; G06Q 30/0246; G06Q 30/0202; G06Q 30/0277

(57) ABSTRACT

Aspects of the subject disclosure may include, for example, providing, by a processing system, a user interface presented at a communication device of a broker for managing curated deals in electronic advertising The processing system can obtain, via the user interface, user input comprising pricing data, targeting data, margin data, and assigned buyers. The processing system can generate multiple curated deals based on combinations of prices, targets and margins derived from the pricing data, other targeting data, and other margin data, respectively. Other embodiments are disclosed.

### FIELD OF THE DISCLOSURE

The subject disclosure relates to a method and apparatus for managing deals in electronic advertising including deals of brokers.

### BACKGROUND

Electronic advertising (e.g., online display advertising) delivers promotional messages to consumers by using visual advertisements (or “ads”), such as in web pages. A publisher of a web page can insert an ad space in a web page where the ad space is a region of a web page (or other electronic document) where an advertisement can be placed. When the web page is displayed in a browser, a visual advertisement (e.g., a creative) of an advertiser can be dynamically retrieved from an ad server for the advertiser, and displayed in the ad space. Serving a creative on a web page for displaying is often referred to as an impression.

A collection of one or more ad spaces on web pages served by web sites of a publisher can be referred to as ad space inventory. Publishers can sell their ad space inventories, such as to advertisers. Multiple publishers and multiple advertisers can participate in auctions in which selling and buying of ad space inventories take place. Auctions can be conducted by an ad network or ad exchange for a group of publishers and a group of advertisers.

Selling and buying ad spaces can be based on pricing or payment models such as cost per thousand impressions (CPM), cost per click (CPC), and cost per action or acquisition (CPA). In the CPM model, advertisers typically pay for every impression of their advertisement; the price paid for each impression is measured in price per 1000 (“mille”) impressions. In the CPC model, advertisers typically pay each time a viewer clicks on their advertisement. In the CPA model, advertisers pay for every action, such as a sale or registration, completed as a result of a viewer clicking on their advertisement.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a data flow in a system that provides broker deal electronic advertising in accordance with various aspects described herein.

FIG. 2B is a block diagram illustrating an example, non-limiting embodiment of a system that provides broker deal electronic advertising in accordance with various aspects described herein.

FIG. 2C depicts an illustrative embodiment of a method that provides broker deal electronic advertising in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

FIG. 7 is a block diagram of an example, non-limiting embodiment of a communication system that provides management of curated deals in accordance with various aspects described herein.

FIG. 8 is an example, non-limiting embodiment of a user interface that can be used with a platform that provides management of curated deals in accordance with various aspects described herein.

FIG. 9 is an example, non-limiting embodiment of a portion of a user interface that can be used with a platform that provides management of curated deals in accordance with various aspects described herein.

### DETAILED DESCRIPTION

The subject disclosure describes, among other things, illustrative embodiments for deal curation (including curated deal auctions which can be conducted) where a broker (also known as a curator) aggregates inventory across multiple sellers and offers that up to buyers. In one or more embodiments, a user interface is provided that allows a broker or curator to manage curated deals, including changing parameters during a campaign. The user interface also allows obtaining forecast data including recommended margins. The user interface also allows initiating automated or programmatic management of one or more curated deals including automatically adjusting a margin of the curated deal according to a prediction of success in fulfilling the curated deal. Various other features are provided by the user interface that facilitates a broker or curator maintaining control over multiple curated deals. The present Application can include features for managing electronic advertising, including managing broker curated deals, as described in U.S. patent application Ser. No. 16/717,243 filed Dec. 17, 2019 and entitled METHOD AND APPARATUS FOR MANAGING BROKER CURATED DEALS IN ELECTRONIC ADVERTISING, the disclosure of which is hereby incorporated by reference herein in its entirety.

In one or more embodiments, the selection of a creative to fill an ad space can be done via a number of different techniques which can also include a combination of techniques such as through use of a unified platform including one or more of direct sales, open exchange, and/or private exchanges. The creative can be of various types including a visual or audio advertisement such as an image, an animation, a video clip, or an audio clip. Other types of a creative are possible. As an example, certain auctions can be conducted that involve two parties: a seller who's offering inventory on an exchange and a buyer that targets that inventory. As another example, alone or in conjunction with the auctions, deal auctions (e.g., including deals that are provided via an SSP server and/or deals that are provided via the equipment of the entity managing the advertising exchange) can be conducted where a seller packages their own inventory into a deal object and offers preferential terms (e.g., pricing, priority, and/or creative attributes) to a specific buyer. As yet another example, alone or in conjunction with the auctions and/or the deal auctions, curated deal auctions can be conducted where a broker aggregates inventory across multiple sellers and offers that up to buyers. For instance in some curated deal auctions, the broker can augment the curated deals with other data, such as data collected by or otherwise obtained by the broker (e.g., a merchant website that collects sales history data for users and that operates as a broker to aggregate inventory across multiple sellers and offers that up to buyers while also providing collected data to facilitate the curated deals). Other data can also be provided (e.g., subject to opt-in or authorization of the end users) including content consumption history, search histories, and so forth.

In one or more embodiments, the curated deals can be done without any preferential terms or access to buyers. In one or more embodiments, the broker can arbitrage on the inventory. In one or more embodiments, the exchange can impose a fee on the broker for this advertising product that they are offering. In one or more embodiments, curated deals can be in various forms such as curation activity where the seller is passively included (i.e., inventory aggregation deals) and/or curation activity where the seller is taking deliberate action to be a part of the deal (i.e., roll up deals). For example, a curated deal that is an inventory aggregation deal can target any seller inventory available on the exchange. In this example, the curated deal may have no additional visibility into the inventory than an exchange buyer. As another example, a curated deal that is a roll up deal can include the seller explicitly contributing inventory into curated deals by providing a deal (e.g., a seller deal) for the curation member to target. For instance, the seller's deal may provide preferential access and/or pricing. In one embodiment, exchange curated deals or multi-seller deals can be implemented which are curated deals where the broker is operated by an entity providing or otherwise supporting the unified platform. For example, the exchange curated deals can provide buyers with access to data and information to provide for a better understanding of supply, brand-safety, and/or other purchasing factors that facilitate decisions by the buyers. In one embodiment, an entity providing or otherwise implementing an exchange curated deal can apply a seller specific charge on these types of transactions. In one or more embodiments, curated deals such as exchange curated deals can include packaging of service provider data (e.g., first party data) to the buyers such as based on authorizations provided by the end users. For example, browsing history related to a particular type of product can be packaged in an exchange curated deal so that buyers can better understand the interests of the end user. The particular type of data being packaged can vary and can include one or more of historical content consumption, search history, purchase history, demographics, and so forth such as based on authorizations provided by the end users. In other embodiments, curated deals such as exchange curated deals can be provided without packaging first party data to the buyers. Other embodiments are described in the subject disclosure.

One or more aspects of the subject disclosure are method in which a processing system can provide a user interface presented at a communication device of a broker for managing curated deals in electronic advertising. The processing system can obtain, via the user interface, user input comprising targeting data, margin data, and assigned buyers. The processing system can generate a curated deal based on the user input, wherein the curated deal is assigned to the assigned buyers. The processing system can store the curated deal. The processing system can receive an ad call associated with an ad space available in media content that is being presented at an end user device. The processing system can conduct auctions with a group of bidders, where the auctions include a curated deal auction based on the curated deal in which the broker aggregates curated deal inventory across a plurality of sellers including a seller of the ad space, and wherein the curated deal inventory includes the ad space. The processing system can obtain bids from the auctions and can determine a winning bid from among the bids. The processing system can provide a notification associated with the winning bid, wherein the notification causes the end user device to render a creative associated with the winning bid in the ad space.

One or more aspects of the subject disclosure are a device including a processing system with a processor and also including a memory that stores executable instructions that, when executed by the processing system, facilitate performance of operations. The device can provide a user interface presented at a communication device of a broker for managing curated deals in electronic advertising. The device can obtain, via the user interface, first user input comprising targeting data and assigned buyers. The device can generate a curated deal based on the user input, where the curated deal is assigned to the assigned buyers. The device can store the curated deal to be analyzed during a campaign of the curated deal to enable determinations as to whether the curated deal is fulfilled. The device can obtain, via the user interface while the campaign is in progress, second user input comprising a parameter change corresponding to the curated deal. The device can adjust, while the campaign is in progress, the curated deal based on the second user input to generate an adjusted curated deal without reissuing other deal identifications to the assigned buyers. The device can store the curated deal to be analyzed during the campaign that is in progress to enable other determinations as to whether the curated deal is fulfilled.

One or more aspects of the subject disclosure are a method that includes providing, by a processing system, a user interface presented at a communication device of a broker for managing curated deals in electronic advertising; obtaining, by the processing system via the user interface, user input comprising pricing data, targeting data, margin data, and assigned buyers; generating, by the processing system, multiple curated deals based on combinations of prices, targets and margins derived from the pricing data, other targeting data, and other margin data, respectively; and storing, by the processing system, the multiple curated deals to be analyzed during campaigns of the multiple curated deals to enable determinations as to whether any of the multiple curated deals are fulfilled.

One or more aspects of the subject disclosure are a method including receiving, by a processing system, an ad call associated with an ad space available in media content that is being presented at an end user device. The processing system can identify a group of bidders from among a plurality of bidders, where the identifying is based on an analysis of seller's line items, sellers deals, and curated deals, where the seller's line items are associated with buyers, where the seller deals are associated with a seller that aggregates deal inventory of the seller including the ad space and offers preferential terms, where the curated deals are offered by brokers, where the curated deals aggregate curated deal inventory across a plurality of sellers including the seller, and where the curated deal inventory includes the ad space. The processing system can conduct auctions with the group of bidders, where the auctions include a curated deal auction associated with one or more of the curated deals. The processing system can obtain bids from the auctions. The processing system can determine a winning bid from among the bids. The processing system can provide a notification associated with the winning bid, where the notification causes the end user device to render a creative associated with the winning bid in the ad space.

One or more aspects of the subject disclosure include a device having a processing system including a processor; and a memory that stores executable instructions that, when executed by the processing system, facilitate performance of operations. The operations include receiving an ad call associated with an ad space available in media content that is being presented at an end user device. The operations include identifying a group of bidders based on an analysis of line items and a curated deal. The operations include conducting auctions with the group of bidders, where the auctions include a curated deal auction based on the curated deal in which a broker aggregates curated deal inventory across a plurality of sellers including a seller of the ad space, and where the curated deal inventory includes the ad space. The operations include obtaining bids from the auctions. The operations include determining a winning bid from among the bids. The operations include providing a notification associated with the winning bid, where the notification causes the end user device to render a creative associated with the winning bid in the ad space.

One or more aspects of the subject disclosure include a non-transitory machine-readable medium, comprising executable instructions that, when executed by a processing system including a processor, facilitate performance of operations. The operations include receiving an ad call associated with an ad space available in media content that is being presented at an end user device. The operations include identifying a group of bidders based on an analysis of a curated deal. The operations include conducting auctions with the group of bidders, where the auctions include a curated deal auction based on the curated deal in which a broker aggregates curated deal inventory across a plurality of sellers including a seller of the ad space, and where the curated deal inventory includes the ad space. The operations include obtaining bids from the auctions and determining a winning bid from among the bids. The operations include providing a notification associated with the winning bid, where the notification causes the end user device to render a creative associated with the winning bid in the ad space.

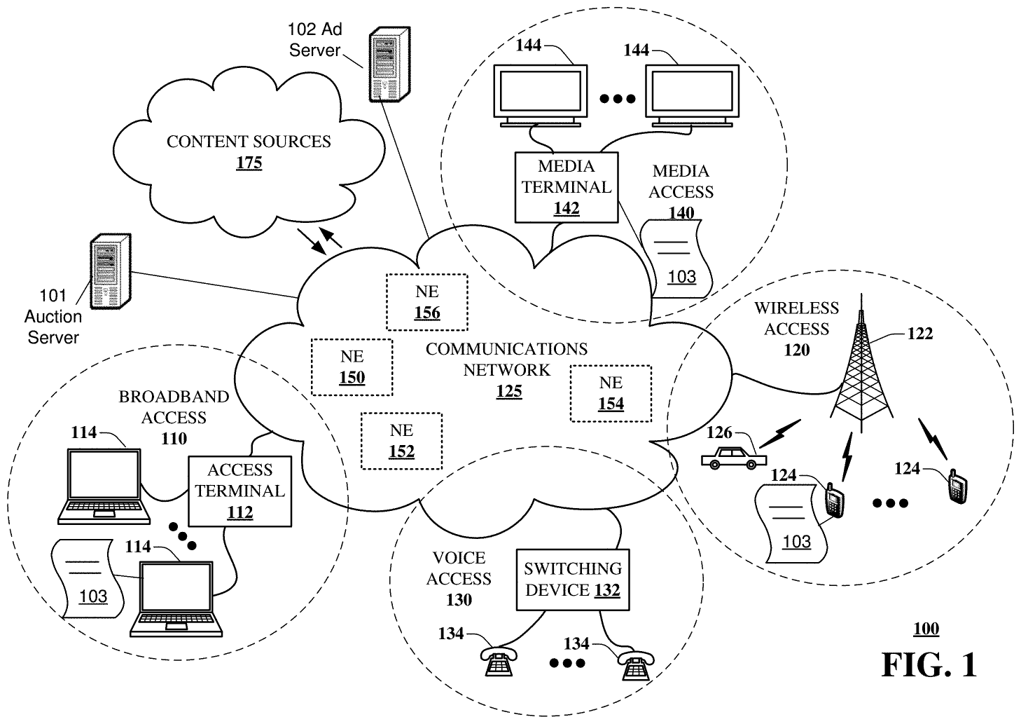

Referring now to FIG. 1, a block diagram is shown illustrating an example, non-limiting embodiment of a communications network 100 in accordance with various aspects described herein. For example, communications network 100 can facilitate in whole or in part offering curated deals for electronic advertising (such as in an ad space in a web page, ad pods in a video, and so forth) where a broker aggregates inventory across multiple sellers and offers that up to buyers. These curated deals can be done alone or in conjunction with other selling techniques including direct sell, open exchange and/or private marketplace techniques. For instance, an ad call, which is associated with an ad space available in media content that is being presented at an end user device, can cause an identification or determination of potential buyers or bidders by a computing system. This process can be performed by the computing system in a number of different ways including based on an analysis of deal profiles, seller's line items, seller deals, and/or curated deals. The various information representative of seller deals, curated deals and so forth can be organized and managed in a number of different ways including through the use of line items. In one embodiment, seller's line items can be associated with buyers, the seller deals can be associated with a seller offering preferential terms to a buyer(s), and/or the curated deals can be associated with brokers that are aggregating inventory of more than one seller which can include third party entities (e.g., distinct from the buyers and the seller). In one embodiment, auctions can be conducted by the computing system with a group of bidders (e.g., bidders that have agreed to or otherwise are configured to engage in curated deals), where the auctions include a curated deal auction in which a broker of the brokers aggregates curated deal inventory across a plurality of sellers including the seller, and where the curated deal inventory includes the ad space. Bids can be obtained from the auctions and a winning bid can be determined from among the bids by the computing system. A notification associated with the winning bid can then be transmitted by the computing system, where the notification causes the end user device to render a creative associated with the winning bid in the ad space. The computing system can be various devices or combinations of devices including auction server 101 which can be in communication with the communications network 125. FIG. 1 illustrates an ad server 102 in communication with the communications network 125, where the ad server can facilitate the process, including delivering of a particular creative of the winning bidder to the end user device presenting the media content which includes the ad space that is being sold. However, one, some or all of the functions described herein can be performed by the auction server 101, the ad server 102, another server not shown, or any combination thereof, including in a virtual computing device or a distributed processing environment. One, some or all of the functions described herein can also be performed in a client-side implementation (e.g., utilizing a script executed by the end user device, ad server 102, or any combination thereof) and/or a server-side implementation (e.g., via auction server 101, ad server 102, another server not shown, or any combination thereof). In one or more embodiments, a CSAI implementation for managing digital advertising can be utilized via a code or script 103 (e.g. a javascript) operating on or otherwise being executed by an end user device that will be rendering the content and ad space. The script 103 can perform various functions including one or more of prebidding, ad insertion, communicating with various devices (e.g., ad server 102 and/or auction server 101) and so forth. In this example, the script 103 can be utilized in conjunction with one or more of the functions described herein where curated deals are analyzed to determine winning bidders.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

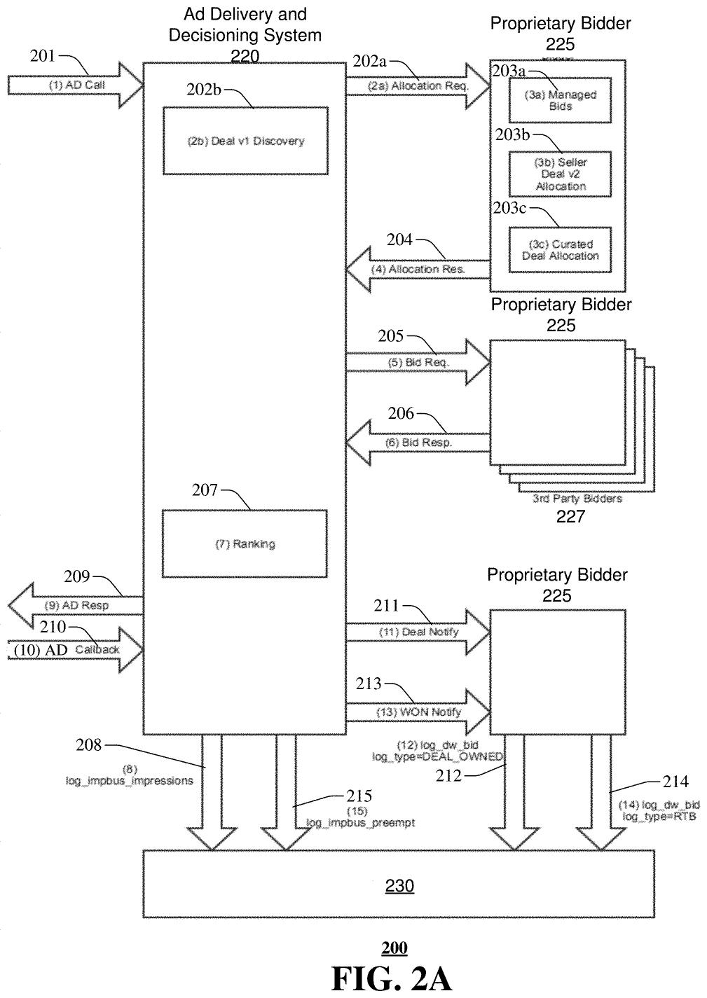

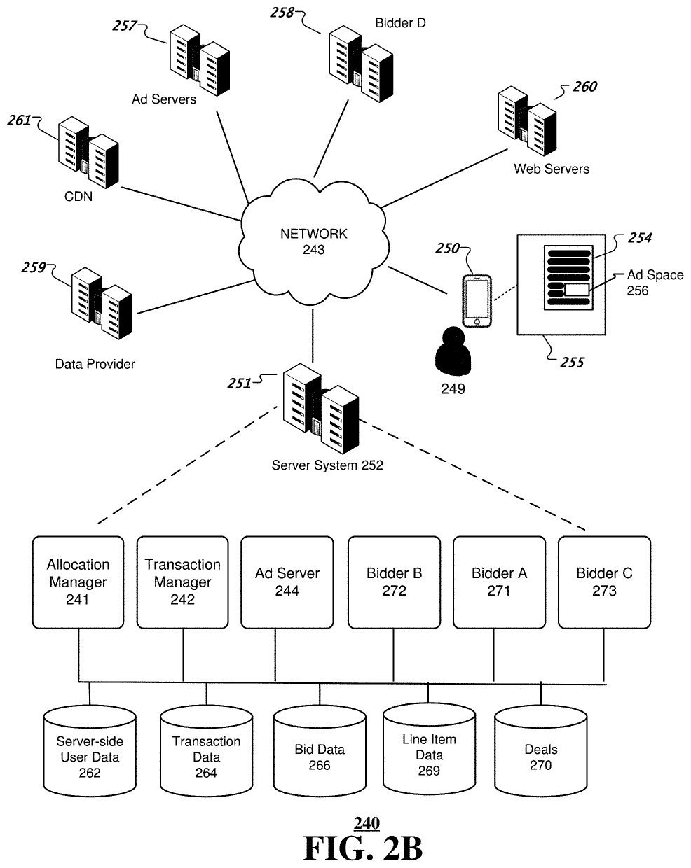

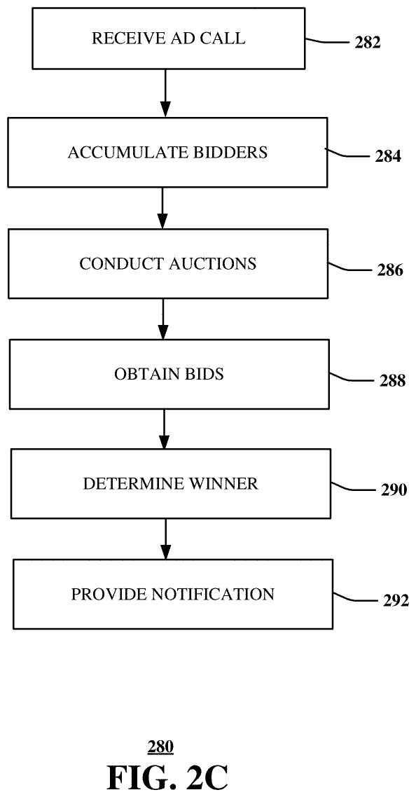

Referring now to FIG. 2A, a block diagram is shown illustrating an example, non-limiting embodiment of a data flow 200 in a system that provides for management of electronic advertising in accordance with various aspects described herein. Various devices and combinations of devices can be utilized to implement the data flow 200 which can be used in conjunction with various systems described herein such as system 100 of FIG. 1. For example, an ad delivery and decisioning system 220 can be employed which can be a server or a server cluster that processes various transmissions and data associated with electronic advertising including one or more of processing ad requests, providing data to members, conducting auction(s), returning ads or creatines to the publishers and/or to end user devices, maintaining and monitoring information to track billing and/or usage, returning auction-result data, and/or enforcing policies such as quality standards. As an example, the ad delivery and decisioning system 220 can allow participants to interface and interact.

In one or more embodiments, data flow 200 can be part of a Server-Side Ad Insertion (SSAI) platform and/or a Client-Side Ad Insertion platform (CSAI) to enable broker curated deals along with other selling methodologies. For instance, the ad space (which can be an ad pod) or other ad inventory can be populated such as through stitching with content by the SSAI server in an SSAI implementation or via a player Software Development Kit (SDK) in the Client-Side Ad Insertion (CS All implementation. Various ad spaces can be utilized, including banner ads and web page spaces.

In one or more embodiments, a proprietary bidder 225 can be utilized which can be an independent bidder, optimization engine, and/or user-interface (e.g., a web-based platform and/or an API-based interface). In one or more embodiments, a networking system (e.g., via a log streaming component) can be utilized which can facilitate distributing data, such as streaming logs from applications into a data warehouse(s). Various configurations can be utilized to provide the functions described herein including the ad delivery and decisioning system 220, the proprietary bidder 225 and the networking/distributing system operating as separate devices or systems that communicate with each other and/or some or all of the ad delivery and decisioning system, the proprietary bidder and the networking system operating on a single server.

At 201, the ad delivery and decisioning system 220 can receive an external ad-call. The ad-call can be triggered by an end user device accessing content in which ad inventory exists (e.g., an ad space in a web page, video game, video, etc.), and can be received from various sources including the end user device. The end user device can be various types of devices that render content including mobile phones, media processors, intelligent TVs, set top boxes, tablets, laptops, vehicle entertainment systems, and so forth.

In one embodiment, if the add-call is generated from or otherwise forwarded by a Supply-Side Platform (SSP) server according to the end user device accessing the content, deal identifications (IDs) representative of SSP deals which are allocated by the SSP server can be included with the ad-call. In one or more embodiments, the SSP server can provide an ad call without including a deal ID. In other embodiments, the ad call comes from the end user device (e.g., a script or javascript running on the end user device) without an SSP server being involved. The ad-call message can include various information, such as pricing information, floor pricing, SSP deal pricing information, SSP deal floor pricing, types of ads that can be served, site or location for the ad, information as to what the publisher wants in the ad, size of the ad, user ID, device ID, domain information, and so forth. In one embodiment, various information provided in the ad call can be obtained from an ad tag associated with the ad space, such as an ad tag that is populated with information by a publisher of the content. In other embodiments, the various information provided in the ad call can be obtained from the SSP server. In other embodiments, the various information provided in the ad call can be obtained from the SSP server and the ad tag. Various techniques can be utilized in providing the ad-call message including triggering the ad-call from a header of the content (e.g., webpage) when it is being loaded by the end user device.

Allocations can be initiated at 202. For example at 202a, the ad delivery and decisioning system 220 can transmit a request to the proprietary bidder 225 for discovery of potential buyers or bidders. In one embodiment at 202b, the ad delivery and decisioning system 220 can evaluate deal profiles to discover deals. For instance, the ad delivery and decisioning system 220 can discover the deals by analyzing data indicative of agreements between buyer and seller where a seller packages its inventory and the packaging and terms of the agreement (e.g., a fixed or floor price, targets, and so forth) are identifiable based on a deal ID. In this example, a buyer can recognize a deal ID and can map it to the particular agreement for decision making as to whether to bid upon or purchase the ad space. For instance at 202b, the ad delivery and decisioning system 220 can monitor for advertising inventory that matches particular targeting attributes of an agreement and can package that inventory into the corresponding deal ID. In one or more embodiments, step 202b can be based on targeting profiles that can identify the types of inventory that are to be packaged together and/or terms of the deal between the seller and particular buyer(s). In one or more embodiments, targeting profiles can be generated by a seller (e.g., the seller associated with the ad space of the add call). In one or more embodiments, there can be several deal IDs representing different deals between the same buyer and seller. In one or more embodiments, there can be several deal IDs representing different deals between different buyers and the seller. In one or more embodiments, step 202b is performed without using deal line items. In one or more embodiments, steps 202a and 202b can be performed in parallel or in overlapping time.

In one embodiment, the request at 202a can be a managed bid request (e.g., demand from a seller that is trafficked in an ad server) which causes the proprietary bidder 225 at 203a and 203b to discover or otherwise determine eligible bidders or buyers and/or eligible deals. For instance, the proprietary bidder 225 can evaluate eligible managed seller's line items at 203a and can accumulates bids. This process can include the proprietary bidder 225 accessing seller's line items that have been generated by a seller (e.g., the seller associated with the ad space of the add call). For example, sellers can create seller's line items through a user interface provided by the proprietary bidder 225 or via another technique or component. Seller's line items allow users to manage direct sales via the line items. The seller's line items can include various parameters, such as one or more of pricing, budgeting, pacing, key value parameters, target viewing rate, targeting information, particular buyer. In one or more embodiments, the seller's line items can be based on arrangements or agreements made by the seller with the buyer. The proprietary bidder 225 at 203b can discover seller's line items that are a match for the ad call, such as based on one or more of the parameters included in the creative line item (e.g., pricing, budgeting, pacing, key value parameters, target viewing rate, targeting information).

As another example, the proprietary bidder 225 can evaluate eligible seller deals and can allocate deal identifications (IDs). This process can include the proprietary bidder 225 accessing seller deals (e.g., deal line items) that have been generated by a seller (e.g., the seller associated with the ad space of the add call) to package multiple ad spaces of that seller. For example, sellers can create seller deals through a user interface provided by the proprietary bidder 225 or via another technique or component. In one or more embodiments, seller deals allow users to manage deals via line items or other designated parameters. The seller deals can include various parameters, such as one or more of pricing, budgeting, pacing, key value parameters, target viewing rate, targeting information, particular buyer. In one or more embodiments, the seller deals can be based on arrangements or agreements made by the seller with the buyer. The proprietary bidder 225 at 203b can discover seller deals that are a match for the ad call, such as based on one or more of the parameters included in the sellers deal (e.g., pricing, budgeting, pacing, key value parameters, target viewing rate, targeting information, particular buyer). In one or more embodiments, steps 203a and 203b can be performed in sequence or can be performed in parallel or in overlapping time. In one embodiment, 203b can be performed utilizing line items created via the proprietary bidder and/or line items that are accessible from and/or created by another device or platform which may be operated by an entity different from the entity operating the proprietary bidder 225.

In one embodiment, the managed bid request can cause the proprietary bidder 225 at 203c to discover or otherwise determine curated deals and/or eligible bidders or buyers. For instance, the proprietary bidder 225 can evaluate eligible curated deals and can allocate curated deal identifications (IDs). This process can include the proprietary bidder 225 accessing curated deals that have been generated by a broker (e.g., an entity different from the seller associated with the ad space of the add call, an entity different from buyers bidding for the ad space, or an entity different from the seller and the buyers) to package multiple ad spaces of multiple sellers. For example, brokers can create curated deals through a user interface provided by the proprietary bidder 225 or via another technique or component. Curated deals allow users to manage curated deals across multiple sellers (with the same buyer or with multiple buyers) via the curated deals. The curated deals can include various parameters, such as one or more of pricing, budgeting, pacing, key value parameters, target viewing rate, targeting information, particular buyer(s), particular seller(s). The proprietary bidder 225 at 203b can discover curated deals that are a match for the ad call, such as based on one or more of the parameters included in the curated deal (e.g., pricing, budgeting, pacing, key value parameters, target viewing rate, targeting information, particular buyer(s), particular seller(s)). In one or more embodiments, the curated deals can be based on agreements that have been established between the broker and the buyer without there being any pre-arranged agreement between the broker and the seller. In one or more embodiments, the curated deals can be based on agreements that have been established between the broker and the buyer and agreements that have been established between the broker and the seller.

In one or more embodiments, this curated deal process can enable auctions that are performed in phases or performed in a segmented fashion across the platform. For instance, inventory aggregation deals can be discovered where the curated deals target seller inventory available on the exchange without any agreement between broker and seller (e.g., specified inventory targeted in a same way that any bidder user would target the seller inventory (such as by domain name) such that the seller does not need to take explicit action to be included). As another example, roll up deals can be discovered where the seller explicitly contributes inventory into curated deals by providing a seller deal for the curation member to target which can include an agreement as to preferential access (e.g., to particular buyers or earlier access) and/or pricing.

In one or more embodiments, this curated deal process can include targeting deal line items discovered in step 203a and/or SSP deals that were received with the ad call. In one embodiment, the evaluation of the eligible curated deals does not target deals that were discovered at 202b by the ad delivery and decisioning system 220. In one or more embodiments, steps 203a and 203b can be performed in sequence or can be performed in parallel or in overlapping time.

At 204, the proprietary bidder 225 can provide a managed bid response to the ad delivery and decisioning system 220. The managed bid response can include information obtained via the discovery of steps 203a, 203b and 203c. For example, the managed bid response can identify managed creative bidders, seller deal IDs, curation member deal IDs and/or roll up curation deals that specify targeted seller deals.

At 205, the ad delivery and decisioning system 220 can send deal and/or Real-Time Bid (RTB) bid requests to all of the discovered eligible bidders (e.g., discovered via steps 201, 202b, 203a, 203b, 203c), such as through the proprietary bidder 225 and/or to other bidder platforms 227 (e.g., one or more other open exchanges that may be operated by entities different from the entity operating the ad delivery and decisioning system 220). For example, the proprietary bidder 225 can discover buyers that desire to participate via one or more of a direct sell process, an open exchange and/or a private marketplace. Additionally, the discovery can identify eligible managed deals and/or curated deals so that these particular buyers can participate in the auctions. The deal and/or Real-Time Bid (RTB) bid requests can be in various formats and can include various information.

At 206, the eligible bidders, via the proprietary bidder 225 and/or via other bidder platforms 227, can provide or otherwise submit deal and/or RTB bids. For example, these bids can specify a price. Other information can also be included in the deal and/or RTB bids, such as bidder identification, creative type, identification of a creative, and so forth.

At 207, the ad delivery and decisioning system 220 can analyze the deal and/or RTB bids that have been received to validate, rank (e.g., by priority and/or price) and/or apply curation fees. This analysis can result in a determination of a winning bid. Various techniques can be applied to determine the winning bid including prioritizing particular buyers due to preferential access agreements, price comparisons, and so forth.

Prioritization of curated deals can be implemented with respect to other deals or bids. For example, system 220 can consider one or more of the following criterion in ranking: bids from sellers line items with their priority; bids against seller deals (e.g., inherit priority from seller deals); bids against curated deals (e.g., these deals can inherit contributing seller deal priority if rolling up deals and/or do not have an associated priority if performing plain inventory aggregation; open exchange bids. In this example, the ranking can be by priority, such as the highest priced bid in the highest priority bucket normally winning. If a seller is reselling in the exchange for this auction, open-exchange bids (e.g., including inventory aggregation curated deal bids) can also compete.

The various information representative of seller deals, curated deals and so forth can be organized and managed in a number of different ways including through the use of line items. Referring back to FIG. 2A, at 208 the ad delivery and decisioning system 220 can generate logs based on the analysis including generating logs for deal IDs for managed deals and/or curated deals. As an example and depending on the bid that has won and whether it is associated with a deal or a curated deal, the ad delivery and decisioning system 220 can log various winning bid information such as one or more of buyer, seller, broker, creative, domain, and so forth. In one or more embodiments, this information or a portion thereof can be selectively shared, such as via an access or distribution device 230, with various entities, including one, some, or all of the buyers, sellers and brokers.

At 209 according to the determination of the winning bid, the ad delivery and decisioning system 220 can respond to the ad-call which can trigger or otherwise enable presentation of a creative corresponding to the winning bid at the end user device. Various techniques and communication protocols can be utilized to cause the creative to be presented at the end user device, including techniques and protocols implemented by the ad delivery and decisioning system 220, a script at the end user device, an SSAI server, an ad server, or another device(s). The rendering process can be implemented in a number of different ways including via an SSAI platform or CSAI platform. In one embodiment, video stitching of the creative into the content can be performed. In one embodiment, the creative can be obtained from an ad server and inserted by way of a script executing on the end user device. In one embodiment, the creative can be retrieved from other sources such as a prebid cache or via a URL to a location in a storage device storing the creative.

At 210 responsive to or otherwise triggered by a rendering of the creative at the end user device, the ad delivery and decisioning system 220 can receive a callback from or otherwise sourced by the end user device. For example, the callback can include an indication of the rendering of the creative at the end user device. In one or more embodiments, the callback can include other information such as an indication of any user interaction with the creative, such as clicking on the ad, fast forwarding of the ad, scrolling past the ad, and so forth.

At 211, the ad delivery and decisioning system 220 can provide a notification associated with the callback in certain circumstances. For example, a deal notification can be sent to the proprietary bidder 225 if the winning bidder was utilizing the proprietary bidder. In one embodiment, if the winning bid was part of a roll up curation deal then the ad delivery and decisioning system 220 provides a deal notification associated with the deal if it was also part of a deal discovered in 203b. In one or more embodiments, the notifications can be used by the bidder for budgeting and pacing purposes.

At 212, the proprietary bidder 225 can process any deal notification. For example, a log can be generated describing a curated deal, a seller deal and various information associated with the deals, such as identifications.

At 213, the ad delivery and decisioning system 220 can send a notification to the winning bidder. In the example of FIG. 2A, this notification is being sent via the proprietary bidder 225 (e.g., where the winning bid participated via the proprietary bidder 225 see steps 205, 206), however, the winning bid notification can be sent by the ad delivery and decisioning system 220 to some other device (not shown), such as where the winning bid was generated via some other platform and not via the proprietary bidder 225 (See steps 205, 206). At 214, if the winning bid was generated via the proprietary bidder 225, then the proprietary bidder 225 can generate a log describing same.

At 215, the ad delivery and decisioning system 220 can generate a log as a result of the call back indicating the rendering of the creative at the end user device. Various information can be included in the log such as identification information for deals and curated deals.

In one or more embodiments, curated deal discovery can be limited to particular members that have authorized same, that are provided permission, or a combination thereof. As an example, the ad delivery and decisioning system 220 can send deals and eligible third party members in a managed request via the proprietary bidder 225 and can indicate to the proprietary bidder the types of allocations are allowed, such as managed, curation, RTB, and/or deals. This can enable the proprietary bidder 225 to analyze and evaluate eligible managed seller's line items, eligible seller deals and curated deals in order to submit back to the ad delivery and decisioning system 220 a managed bid response which includes managed creative bids, deals discovered via step 203a, curation member deals and/or roll up curation deals that that specifically target a seller deal. In one embodiment, only roll up curated deals may be allocated on deal-only inventory. In one embodiment, inventory aggregation curated deals may only be allocated where RTB is permitted. In one embodiment, curated deals themselves do not have a priority. In one embodiment, as long as a seller permits open-exchange on inventory, exchange curated deals are allowed. In terms of prioritization, exchange curated deals can compete with an open exchange.

In one embodiment, roll up curated deals can involve “linking” deals on the ad delivery and decisioning system 220. For example, the seller can contribute a deal ID (via SSP deals or deals discovered at 203a), which allows the broker to target that seller deal with a curation deal line item in order to allocate a curated deal, so that the buyer member targets the curated deal. In one embodiment, the buyer bid will need to satisfy the terms of the curated deal as well as the seller's deal.

In one embodiment, the deal response can indicate to the ad delivery and decisioning system 220 that a curated deal is targeting a seller deal. In one embodiment, SSP deals do not have priority such that curated deals targeting SSP deals will compete with other open exchange demand. In one embodiment, bids against curated deals can compete at the priority of the seller's deal line item. In one embodiment, curated deals may be limited to market price. In one embodiment, a member/seller can include their own inventory into their own curated deal. For example, the member/seller can create a separate deal line item and contribute a deal that the curated deal rolls up.

In one embodiment in a managed phase, a deal discovery phase can be implemented that processes non-managed deal line items. For example, if these deal line items are targeting deals: they can target deal IDs in the request (SSP deal IDs); they can target deal IDs discovered in the managed phase valuation at step 203b for variable pricing; and/or they can include target specific deals (e.g., they may not exclude targeting nor indicate target all). In one embodiment, the deal response can indicate to the ad delivery and decisioning system the targeted seller deal.

In one embodiment, a bidder applies a seller's visibility profiles (VP) (e.g., deal VP>tag VP>publisher VP>member VP) before allocating curated deals so curated deals don't expose attributes of an auction that are hidden from the curation member. In one embodiment, curated deals are only allocated if the buyer member is eligible (e.g., is in the bid request). In one embodiment, the deal bid request floor can be grossed up to include a curation member auction charge (which can be in addition to other charges). In one embodiment, various settings can be implemented at the buyer's control regarding deals becoming active or requiring review. For instance, a buyer can indicate active on new incoming deals or indicate all deals require review before turning active. Another option is that seller-created deals can default to active, but curated deals require review before turning active.

In one embodiment, a sell side deal line item can be utilized where the auction seller member is the same as the line item owner. In this example, a member acting as a seller in this context uses a deal line item (e.g., step 203b) to allocate deals against their own inventory.

In one embodiment, an inventory aggregation curation can be utilized where the auction seller member is not the line item owner. In this example, a member acting as a curator of deals allocates deals against any inventory available in the open exchange. This transaction can have three entities: a seller, a curation member and a buyer. There can be one deal on the transaction, which is the curated deal by the intermediary.

In one embodiment, a roll up curation can be utilized where the auction seller member is not the line item owner and has explicitly shared a deal with the line item owner. In this example, a seller member explicitly opts in by providing a “seller deal” for the curation member to target. The curator member targets the seller deal and packages that inventory into their curated deal. This transaction has three entities, a seller, a curation member and a buyer. The seller has explicitly contributed a “seller deal” that is rolled up into the intermediary's curated deal.

In one or more embodiments, pre-bidding can be implemented (e.g., via a prebid server or by other devices including end user devices) in which communication is established with one or more SSPs or demand partners, such as advertising networks or exchanges. This can enable a seller such as a publisher to have auctions (e.g., simultaneously or overlapping in time) with all or selected SSPs (including ad exchanges). In this manner, sellers or publishers can receive bids on inventory that may be unavailable through a primary ad server and exchange. In one embodiment, the returned bids or a portion thereof can be provided to an ad server or other managing server to compete with direct demand and the primary ad server's exchange. In one or more embodiments, the prebid auctions can be performed in a particular time frame such as within a few hundred milliseconds (e.g. less than 100 or 200 milliseconds), although, other time frames can be utilized by the exemplary embodiments.

In one or more embodiments, data and performance information can be provided to various parties associated with the broker deals including buyers, sellers and/or brokers, such as through a user interface of the proprietary bidder 225 and/or the ad delivery and decisioning system 220. For example, brokers can be provided with analytics reporting and log level data to facilitate manage their curated deals including exchange curated deals.

In one or more embodiments, various models can be established for broker deal businesses such as a self-service programmatic model where a broker sells exchange curated deals to a buyer, and the buyer then targets the deal in one or more of his or her line items; a transparent managed model where a broker sells and manages exchange curated deals via an Insertion Order (TO) (communicated from a buyer) that they trade on behalf of the buyer; and a fixed CPM model where a broker sells and manages exchange curated deals via an IO that they trade on behalf of the buyer. In one or more embodiments, various data and information can be provided to the broker regarding curated deals that have been generated. For example, equipment of the broker can be provided with or otherwise can access information associated with one or more of confirming that any exchange curated deals are delivering as expected; confirming that any change made to an exchange curated deal is behaving as expected; monitoring the delivery and performance of the exchange curated deals; monitoring revenue being generated via fees collected from curated deals; monitoring and optimizing towards a margin being made on an IO basis; monitoring performance on IOs that are being managed; monitoring viewability of the exchange curated deals; monitoring video completion rates on exchange curated deals; reporting out to others the top performing inventory of the exchange curated deals; and/or reporting out to other top performing data segments of the exchange curated deals.

In one or more embodiments, detecting, diagnosing, and/or fixing issues affecting the general performance of an exchange curated deal is addressed to improve on a very time consuming activity. In one embodiment, equipment of the broker can be provided with or otherwise can access information associated with monitoring how many ad requests from the seller(s) matched the criteria of the exchange curated deals. In one embodiment, equipment of the broker can be provided with or otherwise can access information associated with monitoring how many of the overall bid requests included the exchange curated deals of the broker to the buyer(s). In one embodiment, equipment of the broker can be provided with or otherwise can access information associated with monitoring how many of the overall bid responses included the exchange curated deals of the broker. In one embodiment, equipment of the broker can be provided with or otherwise can access information associated with monitoring how many impressions rendered (e.g., sold) from winning bids on the exchange curated deals of the broker. In one embodiment, equipment of the broker can be provided with or otherwise can access information associated with diagnosing and troubleshooting errors effecting an ability to monetize the exchange curated deals of the broker.

In one or more embodiments, deal reporting for buyers and sellers can be provided such as Analytics Reporting and Deal Health/Metrics Reporting. For instance, for buyers, deal reporting can be provided on the deals the buyer targets. As another example, for sellers, deal reporting can be provided on the deals created by the sellers. For curated deals such as exchange curated deals access can be provided to a 3rd entity (i.e., the broker or curator). The broker or curator can be operating in many ways as a buyer and a seller where they are creating deals (e.g., exchange curated deal) like a seller and where they also target deals, like a buyer.

In one or more embodiments, IO, LI, Split (e.g., budget instruction tool), and Deal objects (used to capture agreement including parties, priorities and other terms) can be used by all parties (i.e., buyers, sellers, brokers (curators)), however, access to information or data can be provided via a limited view or limited accessibility. For example in a curated deal, a buyer can view a buyer line item, a buyer IO, a buyer split (e.g., a single line item that has different delivery rules), and a deal/deal ID that targets the buyer. As another example in a curated deal, a seller can view a seller line item, a seller IO, a seller split, and a deal/deal ID created by the seller. As another example in a curated deal, a broker (curator) can view a broker line item, a broker IO, a broker split, and a deal/deal ID created by the broker. In one embodiment, a broker or curator view of a curated deal that targets deal supply discovered via step 203a reports out on two deals: the deals the broker creates and the deals the broker targets.

In one or more embodiments, curated deals can be used in conjunction with various other techniques for managing electronic advertising including CSAI and/or SSAI implementations of prebidding and including ad insertion into various types of content including web sites, video games, long form video, video-on-demand, connected TV, ad pods in video streams, and so forth. For example, winning bids can be determined from analysis of curated deals where a broker aggregates multiple seller inventory and where one or more components or techniques for implementing auctions, ad insertion, business rule enforcement, yield policy enforcement, competitive separation enforcement, and so forth are utilized as described in U.S. patent application Ser. No. 16/560,666 filed Sep. 4, 2019 and entitled Content Management in Over-The-Top Services, the disclosure of which is hereby incorporated by reference herein in its entirety.

Referring now to FIG. 2C, a block diagram is shown illustrating an example, non-limiting embodiment of a system 240 in accordance with various aspects described herein to provide for broker deals in electronic advertising. Various devices and combinations thereof can be utilized to implement broker deals in electronic advertising including employing one or more of the functions of data flow 200 of FIG. 2A, the methodology of FIG. 2B and/or combining with various systems described herein such as system 100 of FIG. 1. System 240 enables management of electronic advertising in a number of different ways which can include curated deals where brokers aggregate inventory for multiple sellers and offer the curated deals to one or more buyers.

In one embodiment, a server system 252 manages allocating of ad space inventory with respect to various types of content including web pages, video games, videos and so forth. In some embodiments, the server system 252 can provide various functions for electronic advertising including real-time ad space data packaging and auctions. The server system 252 can include hardware components, software components, databases, components executing on the same or on different individual data processing apparatus, and so forth, which can be deployed at one or more data centers 251 in one or more geographic locations. Various configurations of the server system 252 can be utilized to perform one or more of the functions described herein (including functions described with other embodiments). For example, the server system 252 can include one, some, or all of: an allocation manager 241, a transaction manager 242, an ad server 244, and one or more bidders (e.g., bidder A 271, bidder B 272, and bidder C 273). The server system 252 can also perform load balancing and/or provide security, such as managing traffic within a single data center or between multiple data centers, and/or managing data protection and access privilege for tenants served by the data centers 251. In one or more embodiments, the server system 252 can also include or have access to memory resources (e.g., distributed and/or centralized physical storage systems) including one or more databases such as a server-side user data database 262, transaction data database 264, bid data database 266, deals database 270 and/or line item database 269.

In one or more embodiments, a broker can generate a curated deal where the broker aggregates inventory across multiple sellers and offers that up to buyers. The broker can create (e.g., through an API or a web page provided by the server system 252) a curated deal and store the curated deal, such as in the line item database 269, the deal database 270 and/or another database. A curated deal or curation deal line item that has been stored can include various information including one or more of identification of a buyer(s) and/or seller(s), terms of any agreements with the buyer(s) and/or seller(s), targeting information, seller inventory (e.g., publishers, sites, sections, pages, ad units, and so forth), audiences (e.g., behavioral, demographic, and so forth), user geography, user technographics (e.g., devices, operating systems, and so forth), content categories, user frequency and recency restrictions, other custom information the seller knows about the user or inventory, and so forth.

In one or more embodiments, the broker can augment the curated deal with other data such as their own data. For example, a broker that also operates a search engine can include search histories (e.g., with the authorization of the end user) to better allow potential buyers to understand the interests of the end user and facilitate any purchasing decision by the buyers. In one or more embodiments, such as in an exchange curated deal, the broker can also operate or otherwise manage the exchange and can provide various data to buyers (e.g., subject to end user authorization or opt-in) such as service provider collected data (e.g., content consumption history).

In one embodiment, a broker can obtain data associated with end users (e.g., with the permission of the end users) where the data is derived from the end users accessing or otherwise interacting with an electronic product of the broker (e.g., a web page, a search engine, a merchant website, a video game, and so forth). For instance, the data can be associated with an interest in outdoor activities such as detecting purchases of outdoor equipment, detecting consumption of outdoor activity content, detecting search queries for outdoor activities, detecting location information corresponding to outdoor activities, and so forth. In this example, the broker can generate a curated deal (e.g., create a curated deal line item) which aggregates multiple sellers associated with outdoor activities (e.g., web pages of different publishers that describe hiking) and targets buyers that are advertising products for hiking (e.g., different hiking boot companies). In one embodiment, the curated deal can involve multiple sellers and a single buyer. In one embodiment, the curated deal can involve multiple sellers and multiple buyers. For example, a broker can make an agreement with multiple buyers for inventory across multiple sellers, such as a curation deal line item that identifies two buyers that will have each of their creatives inserted into the same ad pods (e.g., next to each other) for multiple sellers of a long form video (e.g., connected TV or OTT media services). In one or more embodiments, a broker can obtain data associated with end users (e.g., with the permission of the end users) from other sources, such as purchasing the user data from a third party. In one embodiment, the broker can provide its own user data in combination with user data obtained from a third party (e.g., with the permission of the end users), such as a broker that provides user data corresponding to search histories where the broker operates a search engine and also provides user data corresponding to purchase histories that are obtained from a particular merchant or payment service.

In one or more embodiments, the curated deals may or may not include preferential access to buyers. The broker may or may not arbitrage on or otherwise implement reselling of the inventory. The curated deals may or may not include inventory that is arbitraged or otherwise being resold by other than the publisher, such as a curated deal where at least one of the sellers of the multiple sellers of the aggregated content is not a publisher of the content but rather a reseller of the ad space in the content. In one embodiment, an exchange can impose a fee on the broker for implementation of the curated deal.

In one or more embodiments, a seller can negotiate with a buyer and can reach an agreement on pricing or other terms on an ad space inventory of the seller. The seller can create (e.g., through an API or a web page provided by the server system 252) a deal (e.g., implemented as a data object) for the agreement and store the deal in the deals database 270. A deal stored in the deals database 270 can include one or more of an identifier for the seller, an identifier for a buyer, an identifier for the deal, an identifier of an ad space inventory of the seller, and a floor price for an ad space in the ad space inventory. For instance in one embodiment, the floor price can specify a minimum bid price for the buyer. In one embodiment, the deal can also include flight dates (e.g., start and ending dates for the deal), one or more user target segments, and/or an auction type. The auction type can specify whether the deal is private or public. In one embodiment for the private auction type, auctions for ad spaces of the deal can be open only to buyers having agreements with the seller on the deal's corresponding ad space inventory. In another embodiment for the public auction type, auctions for ad spaces of the deal can be open to every eligible buyer and not limited to buyers having agreements with the seller on the deal's corresponding ad space inventory.

A broker deal management process will now be described with respect to a user accessing an application as content, however, the electronic advertising management techniques can be utilized with various types of content including long form video. In one embodiment, a graphical user interface 254 of a software application 255 executing on client device 250 of a user 249 can include an ad space 256 and a corresponding ad tag. The application 255 can be a web browser application, or a software application such as a game application or a maps application. The application 255 can retrieve content presented via the user interface 254 (e.g., a web page) through one or more data communication networks 243 (e.g., the Internet) from, for example, web servers 260 of a publisher, although various sources of content can be utilized. For instance, a web page displayed in a browser window of a web browser (e.g., executing on a personal computer or a media processor) can include an ad space on the web page and a corresponding ad tag. The client device 250 can be various types of devices including a mobile phone, a smartphone, a smart watch, a tablet computer, a personal computer (e.g., laptop computer, desktop computer, etc.), a game console, a vehicle media system or any other end user device.

In one embodiment, the ad tag can include a Uniform Resource Locator (URL)) address (or other addressing indicia) of a device or system from which an ad will be requested (e.g., a URL for the server system 252), statements (e.g., Hypertext Markup Language (HTML) statements) for retrieving and displaying a creative, and/or instructions (e.g., JavaScript instructions) for retrieving and displaying a creative (e.g., displaying the creative in a frame, for example a 160 pixel×600 pixel iframe). In one embodiment, executing the ad tag can cause the application 255 to send (e.g., through the network 243) an ad request or ad call to the addressed device or system (e.g., to server system 252). In some implementations, the application 255 sends an ad request to the server system 252 via another advertising server system such as an ad exchange. In one embodiment, the ad request can include information about the available ad space 256 (e.g., a size for the ad space, an identifier for the publisher), user information (e.g., an identifier of the user 249, data describing the user 249, an Internet Protocol or IP address of the device 250, etc.), and/or system information (e.g., types of the browser and the client device). In one embodiment, the ad request can be composed in JavaScript Object Notation (JSON) or Extensible Markup Language (XML) format and transmitted to the server system 252 using Hypertext Transfer Protocol (HTTP) protocol (e.g., using HTTP POST request method). Although, other ad request formats and transmission methods can be utilized.

In one embodiment, the allocation manager 241 or other components of the server system 252 can attempt to allocate portions of ad space inventory to buyers. A buyer can be an advertiser (e.g., a credit card company, a sportswear company), an ad network, an ad exchange, an advertising agency, or another entity. A seller can be a publisher (e.g., newspaper or social network), an online streaming or gaming service, an ad exchange, an ad network or another entity. In one embodiment, a broker can be an entity that is distinct from the buyers and sellers or can be one of the sellers.

In one embodiment, the allocation manager 241 or other components of the server system 252 can process ad requests, allocate ad space inventory referenced by the ad requests to buyers (e.g., based on agreements between brokers, buyers and/or the seller of the ad space inventory, based on the results of auctions, and so forth), send relevant information to advertisers, return creatives to the browsers or other applications, maintain or otherwise monitor billing and usage data for advertisers and publishers, and/or enforce policies or business rules including quality standards, yield optimization policy, competitive separation, brand safety, frequency capping, and so forth.

The broker curated deals can be utilized in conjunction with other methodologies for managing the buying and selling of ad space. For example, a seller can negotiate an agreement with a buyer on pricing or other terms for an ad campaign. The seller and/or the buyer can create (e.g., through an API or a web page provided by the server system 252) one or more line items (e.g., implemented as data objects) representing the terms of the agreement and store the line items in the line item data database 269. As another example, a buyer can use pre-bidding techniques to place bids on an instance of ad space. For instance, a client-side auction can be conducted such as before the application 255 sends the ad request to the server system 252, although other timing could also be utilized, as well as other pre-bidding techniques including a server-side auction. The seller and/or bidders can create (e.g., through an API or a web page provided by the server system 252) one or more line items (e.g., implemented as data objects) representing the bidders' pre-bids. In these examples, a line item's parameters can include, without limitation, an identifier of a seller, an identifier of a buyer, identifiers of one or more ad spaces from the seller's ad space inventory, ad tags of one or creatives from the buyer's ad campaign, flight dates (e.g., start and ending dates for the ad campaign), one or more user target segments, and/or a price for filling an instance of an ad space with a creative from the buyer's ad campaign. In one embodiment, for line items associated with ad campaigns, the value of the price parameter can be a static price based on the terms of the agreement between the buyer and seller. In one embodiment, for line items associated with pre-bids, the price can be determined based on the buyer's pre-bid.

In one embodiment, the allocation manager 241 or other component of the server system 252 can compare data associated with the instance of the ad space to the parameters of the line items in the line item data database 269 and where more than one line item matches the ad request, the allocation manager 241 can apply prioritization rules to determine winning bids or deals.

Various data can be utilized as part of the management and bid selection process, including data associated with the instance of the ad space 256 such as user segment data and/or user behavioral data. For example, user segment data can include demographic information, such as one or more of age, gender, location, school, and occupation. Other user segment data are possible. User behavioral data can include data associated with a user's online activities, for example, that the user put an item in a shopping cart, the user searched for an item, the user visited an online store (e.g., within a particular time period) that sells the item, and/or a frequency the user searched for the item. Other user behavioral data are possible. Data associated with the instance of the ad space 256 can include contextual data. In one embodiment, contextual data can include the type of the user interface 254 (e.g., a home page, a user interface of a game application, etc.), structure of the user interface 254 (e.g., a number of ads on the user interface 254), content of the user interface 254 (e.g., game, finance, sports, travel, content not suitable for children), an identifier of the ad space, the dimensions of the ad space, and/or timing data (e.g., the current month, day of the week, date, and/or time). Other contextual data are possible.

In one embodiment, user segment data (e.g., demographic information) can be provided by a user to a publisher when the user accesses websites or applications published by the publisher. Some user segment data (e.g., location) can be determined by data associated with the user's client device (e.g., client device 250), such as an Internet Protocol (IP) address associated with the client device. User behavioral data can be collected in various ways such as by an application (e.g., application 255) executed on a user's client device (e.g., client device 250). Contextual data can be determined in a number of different ways such as by analyzing content (e.g., words, semantics) presented in the user interface, transmitted to the server system 252 with the ad request, or obtained using any other suitable technique. Other techniques can be utilized for gathering various data that facilitates decisions by the buyers.

A buyer, seller and/or broker can acquire data associated with an ad space from the ad space's publisher and/or from a data provider (e.g., Proximic of Palo Alto, Calif.). In one or more embodiments, the buyer, seller and/or broker can store user data in the server-side user data database 262. For instance, the buyer can store in the server-side user data database 262 mappings between user identifiers and user segments.

In some embodiments, the allocation manager 241 or other component of the server system 252 can enforce or otherwise implement allocation policies designed to enhance the seller's revenue while also adhering to the terms of the seller's ad campaign agreements. For example, when an ad campaign line item and a pre-bid line item match an ad request, and the pre-bid line item's price for the ad space exceeds the ad campaign line item's price, the allocation manager 241 can allocate the ad space to the pre-bidder, rather than the ad campaign partner. On the other hand, if allocating the ad space to the pre-bidder would jeopardize the system's ability to meet the terms of its agreement with the ad campaign partner, the allocation manager 241 can allocate the ad space to the ad campaign partner, even though the ad campaign line item's price is lower than the pre-bid line item's price.

The server system 252 (e.g., via the allocation manager 241) can select one of the matching line items to fill the ad space based on any suitable information, including, without limitation, bid prices, curated deal terms, prioritization rules, line items' parameters (e.g., the price parameters), terms of ad campaign agreements, and/or status of current ad campaigns (e.g., current pacing of the ad campaign). In one or more embodiments, line items can include priority parameters that represent a priority rank or a priority tier of the line item. In one embodiment, the allocation manager 241 or other component of the server system 252 can select a line item to fill an ad space based, at least in part, on the priority parameters of the matching line items.

In one or more embodiments, a client device 250 can conduct a client-side auction before sending the ad request to the allocation manager 241. During the client-side auction, the client device 250 can receive one or more pre-bids for the ad space from one or more pre-bidding partners. The client device 250 can send the pre-bids to the allocation manager 241 such as by adding data indicative of the pre-bids to a URL (e.g., a URL that the software application 255 calls to send an ad request to server system 252), for example, the pre-bidder identifier and pre-bid value can be encoded as key-value pairs in the URL's query string. After the software application 255 calls the URL to send the ad request to the server system 252, the allocation manager 241 or other component of the server system 252 can parse the URL's query string to determine the pre-bidder identifier and the pre-bid value for each pre-bid.

In one or more embodiments, the allocation manager 241 or other component of the server system 252 can also receive creative data from client device 250 for the pre-bids such as creative identifier or URL being added to the query string. In one or more embodiments, the server system 252 can allocate ad space to a buyer without conducting a server-side auction.

In one or more embodiments, the transaction manager 242 or other component of the server system 252 can implement an auction system that facilitates transactional aspects of ad space inventory and impression trading involving brokers, buyers and sellers. For example, the transaction manager 242 can process requests (e.g., deal or RTB requests) received from the allocation manager 241, conduct auctions (e.g., on behalf of sellers and/or brokers), return creatives to the allocation manager 241 or the software application 255 executing on the client device 250, and/or return auction-result data, for example. The transaction manager 242 can store in the transaction data database 264 various transaction information for each ad space that is transacted by the transaction manager 242 or other components of the server system 252.

In one or more embodiments which can be utilized in conjunction with broker curated deals described herein or where no eligible curated deal line item is discovered, a bidder system or bidder (e.g., bidder A 271) can perform bidding operations on behalf of a buyer. For example, the bidder can receive bid-specific information (e.g., one or more of maximum bid price, target user areas or segments, start and end dates, budget) as input and can generate a bid for a particular instance of an ad space inventory. As another example, a buyer can set up (e.g., through an API or web pages provided by the server system 252) a campaign targeting an ad space inventory with a set of bid-specific information for the ad space inventory and store the bid-specific information in bid data database 266. In one or more embodiments, a bidder can operate outside of or otherwise remote from the server system 252, such as bidder D 258. Continuing with this example, the transaction manager 242 can generate a bid request including information about the ad space, the user, and so forth, and can send the bid request to multiple bidders such as bidder A 271, bidder B 272, and bidder C 273, as well as via the networks 243 to servers of other bidders (e.g., bidder D 258). These bid requests (which can be encoded or compressed) can be composed in various formats such as JSON format and sent to bidders utilizing various protocols such as HTTP POST. The winning bid price can be the highest bid price, a second highest bid price of the auction as determined by Vickrey auction or other second-price auction mechanisms or determined via another winning bidding mechanism or policy.

In one or more embodiments, each bidder can determine an appropriate bid based on its own requirements (e.g., budget, targets in placements, and so forth) and can selectively submit a bid response such as including a bid price and/or an identifier of a creative to be served to the transaction manager 242 or other component of server system 252. In one or more embodiments, the transaction manager 242 or other component of server system 252 can determine a winning bid (e.g., a highest bid) among bid responses received within a specified time period (e.g., 100 milliseconds although other time limits can be applied). In one or more embodiments, the transaction manager 242 or other component of server system 252 can provide a creative associated with the winning bid or identification information (e.g., a URL) of the winning bid creative, such as via the allocation manager 241, which can cause the application 255 to display the creative in the ad space in the user interface 254. In one embodiment, the client device 250 can obtain the creative for the winning bid based on a received URL which enables retrieving the creative from another source, such as an ad server (e.g., ad server 244, or ad servers 257 external to the server system 252), or from servers of a content distribution network (CDN) 261. In one or more embodiments for ad campaign line items, the creatives or URLs of the creatives associated with the line items can be provided (e.g., by the buyer) when the line items are created (e.g., through an API or a web page provided by the server system 252). In one or more embodiments for pre-bid line items, the creatives can be provided by the pre-bidders along with their pre-bids.

In one or more embodiments, the ad server 244 can serve creatives to web browsers or other applications. In one or more embodiments, the ad server 244 can make decisions about which creatives to serve, and/or can monitor clicks or other user interactions with creatives.

In one or more embodiments, the allocation manager 241 can store in the transaction data database 264 transaction information such as one or more of an identifier of the creative served to the ad space, an identifier of the broker, an identifier of the buyer, the user's identifier, the price of the ad space, an identifier of the ad space, an identifier of the seller of the ad space, and/or a time stamp. Other transaction information of a transaction can also be monitored and stored.

In one or more embodiments which can be utilized in conjunction with broker curated deals described herein or where no eligible curated deal line item is discovered, publishers or sellers can allocate portions of their ad space inventory to buyers (e.g., advertisers or ad networks) for the buyers' ad campaigns (e.g., direct ad campaigns or programmatic ad campaigns) through offline agreements. For example, different percentages of the ad space inventory on a landing page of a website during a specified time period (e.g., a week or a month) can be allocated to different advertisers for each of their ad campaigns. These agreements can include a number of terms such as one or more of payment model and/or pricing for the ad space inventory, a desired pacing of the ad campaign (e.g., the time rate at which the publisher's ad spaces are allocated to the ad campaign), targeting parameters (e.g., preferences or limits on which instances of ad space inventory can be allocated to an ad campaign, based on data associated with the ad space inventory), priority of the ad campaign relative to contemporaneous ad campaigns on the publisher's site, and so forth.

In one or more embodiments, these agreements can be implemented and enforced by an allocation manager associated with (e.g., executing on) the publisher's ad server. In one embodiment to implement and enforce the terms of such agreements, the allocation manager can utilize line items and prioritization rules. When a request to fill an available ad space is received, the allocation manager can compare characteristics of the ad space to the parameters of line items representing the publisher's agreements with buyers. If more than one line item matches the ad request (indicating that more than one creative or ad campaign may be eligible to fill the ad space), the allocation manager can apply the prioritization rules to determine which ad campaign or creative fills the ad space.

In one or more embodiments, line items are used to allocate a seller's ad space inventory among buyers in ways that are consistent with the terms of agreements between the seller and the buyers, including terms relating to targeting, pacing, prioritization, number of impressions, and budget constraints. Line items can be implemented or generated in advance of starting an ad campaign, such as where values of parameters of line items (e.g., the values of price and/or prioritization parameters) are set by programmers prior to initiating the ad campaign.

In one or more embodiments which can be utilized in conjunction with broker curated deals described herein or where no eligible curated deal line item is discovered, system 240 can enable publishers to make some ad space inventory available to real-time bidders via server-side auctions. In one embodiment, if a publisher's allocation manager determines that no line items match an ad request, the allocation manager can forward the request to an ad exchange, which can offer the ad space to bidders in a server-side auction. In this example, the ad space can then be allocated to the winning bidder, and the system can serve a creative provided by the winning bidder to fill the ad space.

In one or more embodiments which can be utilized in conjunction with broker curated deals described herein or where no eligible curated deal line item is discovered, system 240 can enable publishers to implement pre-bidding which can be client-side and/or server-side auctions (for example which take place prior to allocating ad space inventory to the ad campaigns of the publishers' direct or programmatic partners). In one embodiment, when an instance of an ad space is available to fill (e.g., when a browser begins to load a web page with an ad space), a system can initiate an auction by requesting bids from pre-bidding partners. For example, auction data describing the results of the auction (e.g., the identity, bid price, and creative of the winning bidder, or the identities, bid prices, and creatives of multiple bidders) can be provided to the allocation manager, which uses the auction data to determine how to allocate the ad space.

In one embodiment, when a bid for an ad space is received from a pre-bid partner, the allocation manager can search for a line item with a buyer identity parameter that matches the identity of the pre-bid partner and a price (or price range) parameter that matches the value of the partner's bid.

FIG. 2D depicts an illustrative embodiment of a method 280 in accordance with various aspects described herein which allow for curated deals to be managed where a broker aggregates inventory across more than one seller and offers it to buyers. Method 280 can be performed by various devices and/or combinations of devices described herein including the auction server 101 and/or the ad server 102 of FIG. 1; the ad delivery and decisioning system 220 and/or proprietary bidder 225 of FIG. 2A; and/or the server system 252 of FIG. 2C. At 282, an ad call can be received by a processing system. For example, the ad call can be associated with an ad space available in media content that is being presented at an end user device. The media content can be various types of content including a web page, a video game, a video, connected TV, Video-on-demand, Over-The-Top content, long form video and so forth.

At 284, the processing system can identify or otherwise discover a group of bidders (or buyers) from among a plurality of bidders (or buyers). This discovery process can be performed in a number of different ways. For example, the identifying can be based on an analysis of seller's line items, seller deals, and/or curated deals, which are created and stored so as to be accessible when the ad call is received. In one or more embodiments, the seller's line items and the seller deals can be generated via a user interface to the ad delivery and decisioning system 220, the proprietary bidder 225 or other devices, by various entities such as a seller (e.g., a publisher of content).

In one or more embodiments, the curated deals can be generated via a user interface to the ad delivery and decisioning system 220, the proprietary bidder 225 or other devices, by various entities such as a broker (e.g., an intermediary to the seller and buyers).

In one embodiment, the seller's line items can be associated with buyers to specify various terms or agreements in conjunction with ad campaigns and bidding on electronic advertising. In one embodiment, the seller deals can be associated with a seller (e.g., a publisher of the media content being presented at the end user device) that is aggregating the seller's inventory in seller deals offering preferential terms, including terms or agreements in conjunction with ad campaigns and bidding on electronic advertising. In one embodiment, the curated deals can be associated with brokers that are aggregating inventory across multiple sellers. For example, the brokers can be third party entities, such as distinct from the buyers and the seller. In another embodiment, the broker can be a seller offering up its own inventory as part of the curated deal.

At 286, the processing system can conduct auctions with the group of discovered bidders, where the auctions include one or more curated deal auctions in which one or more brokers aggregates curated deal inventory across a plurality of sellers including the seller, and where the curated deal inventory includes the ad space. At 288, the processing system can obtain bids from the auctions and at 290 the processing system can determine a winning bid from among the bids. The analysis of the bids and the determining of the winning bid can be performed in a number of different ways, including ranking bids based on price, priority or other factors. At 292, various types of notification(s) can be provided by the processing system based on the winning bid. For example, an ad server and/or the end user device can be provided with the creative or an identification of the winning bid to enable the end user device to render the creative associated with the winning bid in the ad space.

In one embodiment, the auctions can include one or more deal auctions in which the seller aggregates deal inventory of the seller to one or more buyers at preferential terms, and where the deal inventory includes the ad space. In one embodiment, the auctions can include one or more real-time bid auctions (e.g., with demand partners) in which another seller of the sellers offers the ad space to another buyer of the buyers. In one embodiment, the curated deal auction can be based on an indication of the seller prior to the curated deal auction that the ad space is to be included in the curated deal inventory.

In one embodiment, the processing system can determine priorities associated with the bids, where the determining the winning bid is based in part on determining of the priorities. In one embodiment, the processing system can receive a call back message responsive to the end user device rendering the creative. In one embodiment, the receiving the ad call can include receiving deal identification information from a supply-side platform server. In one embodiment, the winning bid corresponds to a particular curated deal of the curated deals, where the particular curated deal has a same buyer as a particular deal identified by the deal identification information. In one embodiment, the winning bid corresponds to a particular curated deal of the curated deal, where the particular curated deal has a same buyer as one or more particular seller deals of the seller deals. In one embodiment, equipment of the brokers store user information associated with a user of the end user device. For example, the brokers can provide a particular service to the end user device (such as a merchant) and can collect data associated with the end user device according to that service. This collected data can be packaged or provided to the buyers to facilitate the decision to purchase the ad space which is being presented to the end user.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, a curated deal can be created by a curator, potentially including inventory aggregation (e.g., targeting of seller domains without explicit action from sellers), roll-up deals (e.g., including deals with individual sellers who actively control and contribute inventory), or curator managed deals (e.g., a curator who also has their own owned-and-operated inventory to include that inventory in a curated deal). In one embodiment, a contributing seller deal is created by a seller, as a way to explicitly contribute inventory to the curator for inclusion in a curated deal. This can be a “roll-up” scenario, where the seller uses more granular control over what's included in curation, and can also potentially provide negotiated pricing and/or priority inventory access. In one embodiment, a contributing curator-managed deal is created by the curator if they also have owned-and-operated inventory, as a way to contribute their own inventory to a curated deal, alongside inventory procured from other sellers also included in that curated deal. In one embodiment, a buyer line item can be utilized which is the object created by the buyer in their DSP (demand side platform operating as a bidder), and which could be a proprietary bidder or other 3^{rd} party bidders. In this example, this line item can target the curated deal, so the buyer can effectively buy all of the curated inventory wrapped in a very simple, single targetable deal ID. In one embodiment, seller line item(s) can be line item object(s) that are not a part of curation, but rather can compete with curation activity among the different representations of demand competing for a seller's inventory

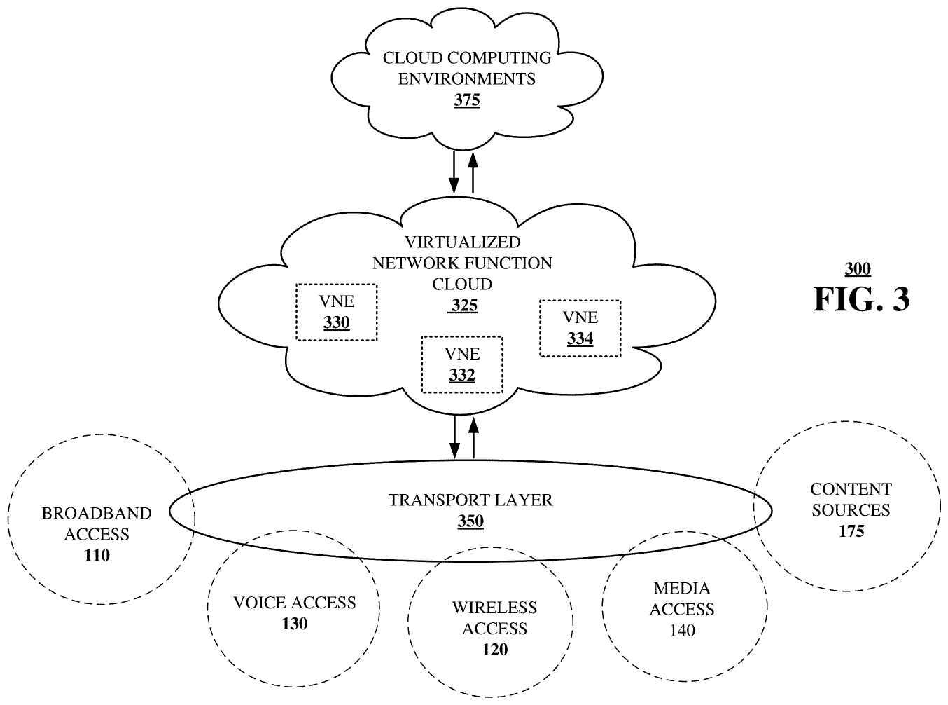

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of communication network 100, the subsystems and functions of data flow 200 and/or 231, system 240 and method 280 presented in FIGS. 1, 2A, 2B, 2C and 2D. For example, virtualized communication network 300 can facilitate in whole or in part (alone or in conjunction with auctions and/or deal auctions), curated deal auctions where a broker aggregates inventory across multiple sellers and offers that up to buyers. For instance in some curated deal auctions, the broker can augment the curated deals with other data, such as data collected by or otherwise obtained by the broker that is related to the particular end user.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

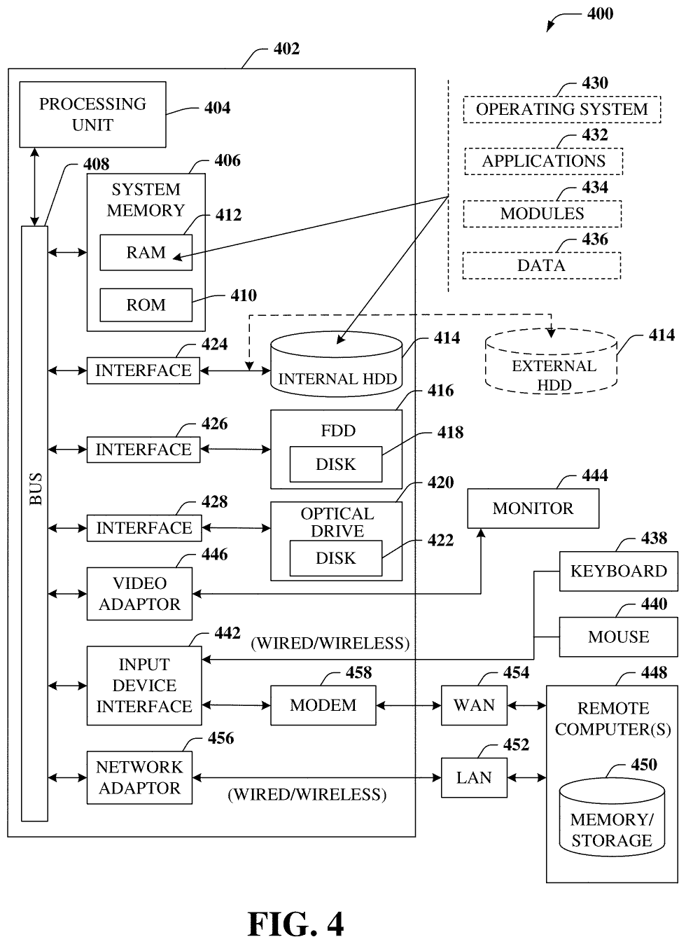

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part (alone or in conjunction with auctions and/or deal auctions), curated deal auctions where a broker aggregates inventory across multiple sellers and offers that up to buyers. For instance in some curated deal auctions, the broker can augment the curated deals with other data, such as data collected by or otherwise obtained by the broker that is related to the particular end user.

As another example, computing environment 400 can: receive an ad call associated with an ad space available in media content that is being presented at an end user device; identify a group of bidders based on an analysis of line items that include a curation deal line item; conduct auctions with the group of bidders, where the auctions include a curated deal auction based on a curated deal of the curation deal line item in which a broker aggregates curated deal inventory across a plurality of sellers including a seller of the ad space, and where the curated deal inventory includes the ad space; obtain bids from the auctions; determine a winning bid from among the bids; and provide a notification associated with the winning bid, where the notification causes the end user device to render a creative associated with the winning bid in the ad space. In one embodiment, the line items include seller's line items and seller deals, where the seller's line items are associated with buyers, and where the seller deals are associated with a seller that aggregates deal inventory of the seller including the ad space and offers preferential terms. In one embodiment, the winning bid corresponds to the curation deal line item that has a same buyer as a particular seller deal of the seller deals. In one embodiment, the auctions include a deal auction associated with one or more of the seller deals. In one embodiment, the broker is a third party entity distinct from buyers and the seller, and where the curated deal auction is based on an indication of the seller prior to the curated deal auction that the ad space is to be included in the curated deal inventory. In one embodiment, a call back message can be received responsive to the end user device rendering the creative. In one embodiment, the receiving the ad call comprises receiving deal identification information from a supply-side platform server. In one embodiment, the auctions include a real-time bid auction in which bid requests are transmitted to a plurality of Supply-Side Platform (SSP) servers, and where bid responses are received from one or more of the plurality of SSP servers within a time deadline. In one embodiment, equipment of the broker stores user information associated with a user of the end user device.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

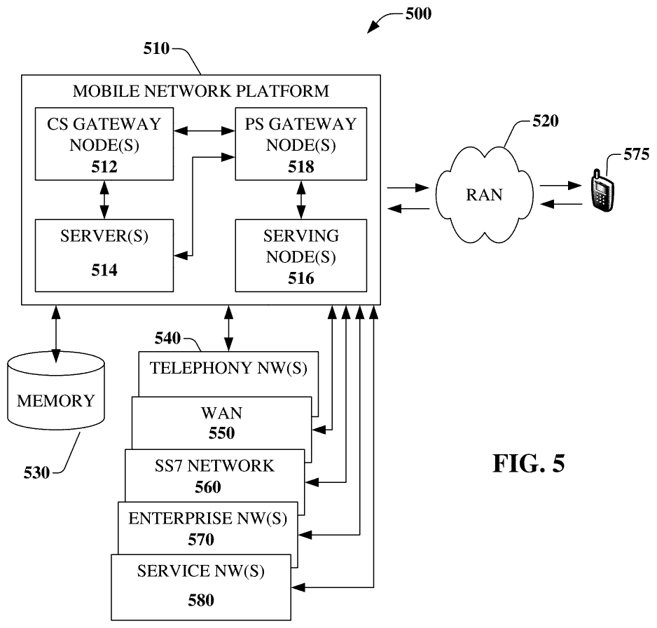

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part (alone or in conjunction with auctions and/or deal auctions), curated deal auctions where a broker aggregates inventory across multiple sellers and offers that up to buyers. For instance in some curated deal auctions, the broker can augment the curated deals with other data, such as data collected by or otherwise obtained by the broker that is related to the particular end user. In one embodiment, platform 510 can facilitate receiving an ad call associated with an ad space available in media content that is being presented at an end user device; identifying a group of bidders based on an analysis of line items that include a curation deal line item; conducting auctions with the group of bidders, where the auctions include a curated deal auction based on a curated deal of the curation deal line item in which a broker aggregates curated deal inventory across a plurality of sellers including a seller of the ad space, and where the curated deal inventory includes the ad space; obtaining bids from the auctions; determining a winning bid from among the bids; and providing a notification associated with the winning bid, where the notification causes the end user device to render a creative associated with the winning bid in the ad space.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

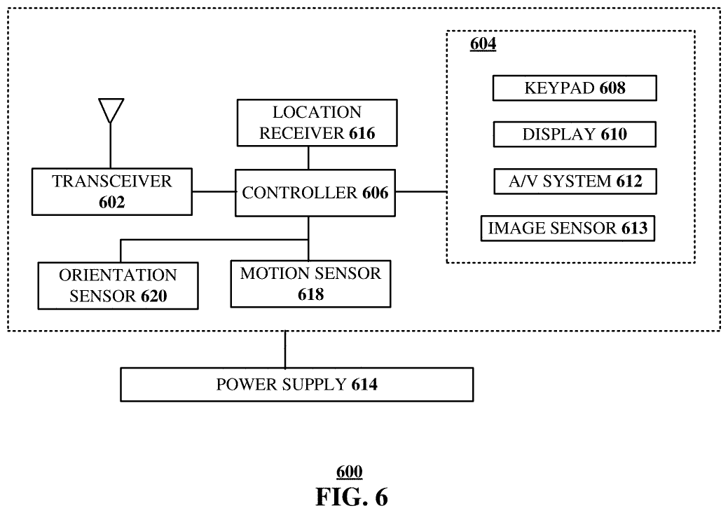

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part (alone or in conjunction with auctions and/or deal auctions), curated deal auctions where a broker aggregates inventory across multiple sellers and offers that up to buyers. For instance in some curated deal auctions, the broker can augment the curated deals with other data, such as data collected by or otherwise obtained by the broker that is related to the particular end user.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor, programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

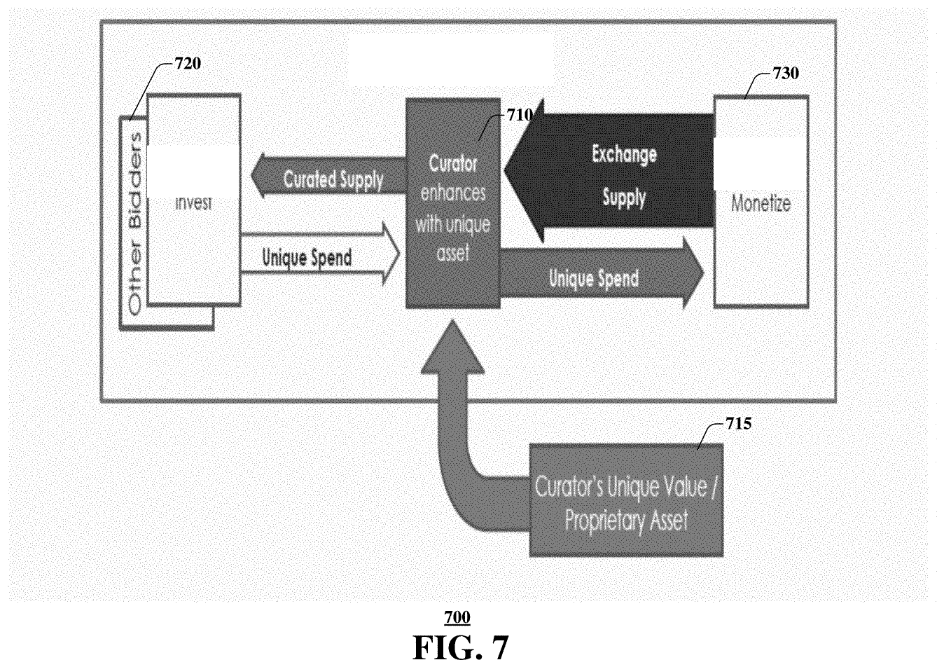

Referring now to FIG. 7, a block diagram is shown illustrating an example, non-limiting embodiment of a system 700 in accordance with various aspects described herein to provide for broker or curated deals in electronic advertising. Various devices and combinations thereof can be utilized to implement these deals in electronic advertising including employing one or more of the functions of data flow 200 of FIG. 2A, the components and methodology of FIG. 2B and/or combining with various systems described herein such as system 100 of FIG. 1. System 700 enables management of electronic advertising in a number of different ways which can include curated deals where brokers aggregate inventory for multiple sellers and offer the curated deals to one or more buyers.

In one or more embodiments, deal curation is managed in which users via equipment 710) can bring their own proprietary assets (e.g., data or technology 715) to the platform 700, such as audience data, negotiated rates, optimization talent, investment strategy, and so forth. As an example, a broker can have data associated with a particular user, such as an e-commerce site that has collected purchase and browsing history of the viewer. The broker can offer this viewer data to buyers and/or sellers to facilitate fulfillment of curated deals. For instance, a publisher (e.g., an outdoor online magazine) would be interested in knowing that its current viewer had previously purchased or browsed for hiking shoes, which the e-commerce site would know due to its collected data. A buyer (e.g., an outdoor gear retailer) would want to target a viewer that is likely to or has shown a propensity to purchase outdoor gear. The ad space in this example may be more valuable because it is more likely to result in a sale and therefore the seller may want a higher price for the ad space and/or the buyer may be willing to pay a higher price for the ad space. This viewer data via the platform 700 can be provided in conjunction with the curated deal to the buyer(s) and/or seller(s) to facilitate fulfilling the curated deal and purchasing of the ad space.

As an example, equipment 710 can be of a third-party broker or curator and can allow for logging in to a tool to implement management of curated deals. In one or more embodiments, new marketplaces can be created by users which the users can then control for buyers (e.g., via equipment 720) on an SSP supply platform (e.g., via equipment 730). For example, users (e.g., curators or brokers) can have their own member seat on an ad exchange, which the user can utilize to group supply into deal IDs for buyers. In one or more embodiments, some or any demand side platform (DSP) plugged into the exchange can buy curated deals. In one or more embodiments, the generated curated deals (e.g., format(s)) can be compatible with and/or accessible by multiple ad exchanges, multiple DSPs, multiple SSPs and/or combinations thereof so that the curated deal is not limited to use with a single DSP, SSP or ad exchange. In one embodiment, users can create unique media products that can only be bought on the exchange and can drive unique demand to sellers that is only available on the exchange. In one or more embodiments, deal curation can be provided to users as a technology offering in its own right in addition to it being used by the exchange manager to create media products. In one or more embodiments, users (e.g., curators or brokers) can be provided with tools to create a revenue stream through brokered deals, and publishers can receive the benefit of curated demand being driven to their supply.

One or more of the exemplary embodiments can address various drawbacks encountered with electronic advertising for various different parties or entities. As an example, some publishers (e.g., e-commerce companies, telecom companies, retailers, and so forth) may have collected data assets (e.g., purchase history, consumption history, search history, and so forth), but may also be reluctant to lose control of that data. In one or more embodiments, platform 700 enables the collected data asset to remain under the user's control. At the same time, buyers can be reluctant to have data owners trade media on their behalf, and so data holders and buyers can find it difficult to transact with each other. Data holders might make their assets available, but that may also be in sales channels that buyers don't want to buy through. In one or more embodiments, platform 700 enables the data holders and buyers to maintain their respective control while still transaction via the curated deals.

As another example, marketers (e.g., consumer goods manufacturers) may want to take a greater role in shaping supply for their agencies in order to control fees and leverage their spend for savings they have negotiated with exchanges, but they may also not have the particular tools that facilitate such control, especially if they do not buy their own media. As yet another example, holding company or marketer employees that negotiate financial incentives with exchanges or sellers directly may want to have a greater role in controlling eligible supply for their traders to better control fees, for example by only allowing traders to buy inventory on which the exchange fees are reportable to the holding company or marketer, and/or leverage their spend for particular treatment that they have negotiated with publishers, but they do not have the tools to easily do so. In one or more embodiments, platform 700 enables the marketers and/or holding companies (as well as other users) to control the eligible supply for their media trading teams across any DSP technology the trader may decide to use.

Some holding company supply strategists must rely on media traders to execute changes out at a campaign level across distributed trading teams, which can be complicated, error prone, difficult to report on, and/or not scalable. In other examples, publisher consortiums have similar issues of wanting to partner together to sell media products that span their collective properties and are seen as centralized to buyers, but the publisher consortiums desire to maintain separate account access and independence to continue to sell, price, and control ad quality with buyers in setup. In one or more embodiments, platform 700 enables the holding companies and/or publisher consortiums (as well as other users) to maintain their desired level of control while forming commercial partnerships.

As a further example, holding company or independently operating barter agencies may negotiate discounts with sellers to work in programmatic channels, which the barter agency to service programmatic budgets and allow buyers enhanced optimization capabilities, but they do not have an easy way to take part in the financial transaction between DSP and SSP, threatening any high-margin business. In yet another example, performance agencies may desire to help buyers optimize campaigns through sophisticated services and data science resources but, when relying on DSP technology, can be disintermediated when DSPs enter contracts directly with marketers. One or more of the exemplary embodiments, provide a platform and a user interface that can facilitate addressing some of these drawbacks described herein through deal curation.

In one or more embodiments supply managers are provided with an operationally efficient way to aggregate supply in complex ways while being exposed to traders in a simple way. In one or more embodiments, the platform and user interface for deal curation facilitates supply path decisions being eliminated from the trader's scope, which can facilitate buying targeted supply at scale. In one or more embodiments, barter managers can enable their existing business model of monetizing negotiated publisher discounts to be utilized via programmatic channels. In one or more embodiments, the platform and user interface for deal curation facilitates rebates being received from the barter agency for select supply. In one or more embodiments, asset monetizers can create a new revenue stream on proprietary assets like audience data or optimization expertise. In one or more embodiments, the platform and user interface for deal curation facilitates access to new and differentiated data assets.

In one or more embodiments, a user interface provides a self-service tool for a broker or curator to set-up, adjust and otherwise manage deals rather than requiring a software team managed by the platform provider to set it up for the particular user. In one or more embodiments, the broker or curator is not required to engage in specific integration with particular supply. System 700 facilitates generating and managing curated deals without requiring specific implementation requirements to access a seller's supply. In this example, a broker or curator does not need to approach or otherwise work directly with the seller to be configured specifically with that publisher and the formats or procedures utilized by that publisher. System 700 allows data businesses to manage themselves as brokers or curators such that businesses having proprietary data can provide some or all of that proprietary data as part of selling of the curated deal.

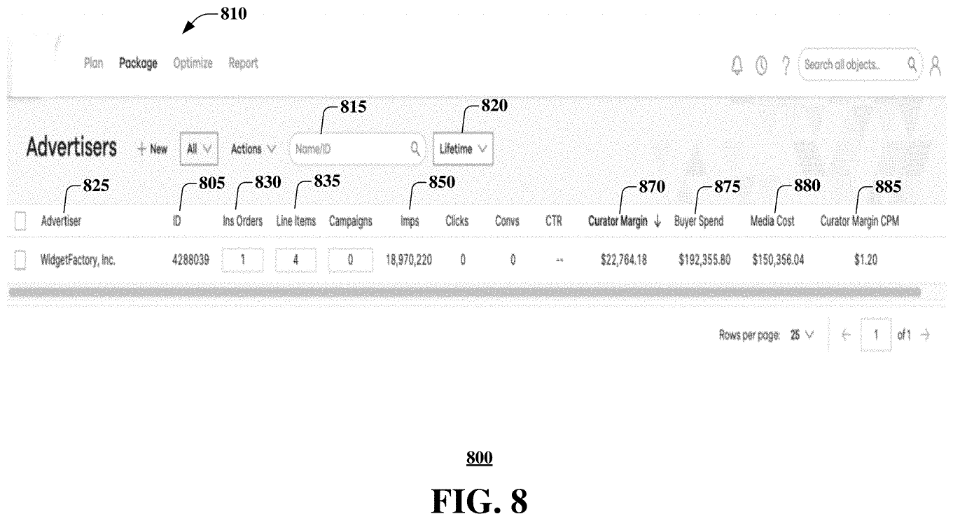

Referring now to FIG. 8, an example, non-limiting embodiment of a user interface 800 that can be utilized with system 700 (or other embodiments that facilitate managing curated deals) is shown in accordance with various aspects described herein to provide for broker or curated deals in electronic advertising. Various devices and combinations thereof can be utilized to generate the user interface 800 that facilitates implementing curated deals in electronic advertising including employing one or more of the functions of data flow 200 of FIG. 2A, the components and methodology of FIG. 2B and/or combining with various systems described herein such as system 100 of FIG. 1. User interface 800 enables management, by a broker or curator, of deals in electronic advertising in a number of different ways which can include inputting information that generates curated deals where brokers aggregate inventory for multiple sellers and offer the curated deals to one or more buyers. The user interface 800 provides an example of an interface that can be utilized for managing electronic advertising including broker curated deals, however, other embodiments can be utilized that provide different features (e.g., different windows, different screens, different buttons, different links, different drop down menus, different selectable options, different configurations of the user interface, and/or different graphical information) for performing the various functions described herein. It should also be understood that the user interface 800 is one example of how to deliver various functionality (e.g., forecasting, margin selection, obtaining user input, generating curated deals, adjusting curated deals, and so forth), however, other techniques can also be utilized including providing or otherwise facilitating the use of one or more APIs to enable one or more of the functions described herein with respect to managing electronic advertising including curated deals.

In one or more embodiments, user interface 800 allows a broker or curator to manage their curation activity with functions for discovering and planning curation activity, packaging individual curated deals for buyers to purchase and execute with contributing inventory, data, pricing, etc., managing active curated deals to monitor performance, identify issues, and tune as necessary to improve performance, reporting on the results of curation activity to track and monitor the business, and so forth. These functions can be provided by way of various techniques including various interface configurations, APIs and so forth. As one example, a log-in can be provided to access a menu having one or more windows or screens, such as a plan window, a package window, an optimize window, a report window, and so forth. In this example, any number and configuration of the windows can be utilized including combining functionality into particular window(s). Links or buttons 810 for accessing such windows can be provided. In one or more embodiments, one, some or all of these windows can be self-configurable so the user can be provided with a format that they desire.

User interface 800 and platform 700 allows for product catalog management including enabling codification of targeting configurations by a user (e.g., a broker or curator that may be distinct from buyers and sellers) where the particular configurations may be utilized many times over so that the user can easily operationalize when the user desires to sell or otherwise implement a deal. User interface 800 also facilitates forecasting which allows the user to determine how much can be sold and how it can be priced, which can include estimating what can be sold and at what price.

In one or more embodiments, functions for discovering and planning curation activity can be provided which enable the broker or curator to support or engage in pre-sales activities. These functions can be provided in a number of different ways such as through the user interface 800 (e.g., the plan window (the link 810 thereto is shown in FIG. 8)), through one or more APIs, and/or through other techniques. For example, a broker or curator can define, save, and/or organize an ad product catalog. In one or more embodiments, a broker or curator, such as but not limited to via the user interface 800, the plan window, one or more APIs or other techniques, can discover relevant inventory, forecast scale and/or understand price. In one or more embodiments, a broker or curator, such as but not limited to via the user interface 800, the plan window, one or more. APIs or other techniques, can define and organize templates to populate an ad product catalog. In one or more embodiments, a broker or curator, such as but not limited to via the user interface 800, the plan window, one or more APIs or other techniques, can access forecast and pricing tools, such as generating and accessing forecast data for a customized configuration of targeting variables associated with a curated deal. This forecast and pricing data is helpful in advising the end buyer on the overall scale, reach, and budgets they can plan campaigns around. In one or more embodiments, a broker or curator, such as but not limited to via the user interface 800, the plan window, one or more. APIs or other techniques, can access particular forecasting information that has been generated by the platform 700 such as impressions and user reach available over a particular time frame, an estimated bid price to win rate curve to understand potential cost, a domain list to detail what seller supply meets the deal targeting criteria, and other analytics that better describe the supply that meets the deal targeting criteria in standard ways, such as devices, supply types (web/app), demographic segments, and so forth.

As a curator or broker, a user, such as but not limited to via the user interface 800, the plan window, one or more APIs or other techniques, can define and save a template for media products with specific targeting, pricing, and/or margin combinations so that the user has an easier way to standardize deals across operations staff, and execute against deals that the user will sell to many different buyers. Margins can include fees that a broker can charge or otherwise add to the price of the ad space as part of the curated deal. Like any media seller, curators can have a set of “rate card” or “off the shelf” products that will be their starting point for any sale. In one embodiment where the curator is also managing the platform, the curator can group a specific list of sellers into a “Tier 1 Supply” template. In another embodiment, a curator can group a number of different data segments together (e.g., five—although any number can be used) on a list of a number of seller deals (e.g., twenty five—although any number can be used) with a completion rate target as a defined product. For instance, these templates can provide operational value in generating a forecast in bulk, or to pre-load complex targeting requirements, as opposed to requiring a re-defining each and every time a user wants a forecast for them.

As a curator or broker, a user, such as but not limited to via the user interface 800, the plan window, one or more APIs or other techniques, can organize media products into specific groups to provide an easy way to manage a large volume of products. Curators may have hundreds or thousands of media products over time, and efficient organization of the media products is a benefit. As a curator or broker, a user, such as but not limited to via the user interface 800, the plan window, one or more APIs or other techniques, can keyword search for media products by name, to provide an easy way to find products regardless of how they are organized. Curators may have hundreds or thousands of media products over time, and an efficient technique to search for them is a benefit. As a curator or broker, a user, such as but not limited to via the user interface 800, the plan window, one or more APIs or other techniques, can set target prices and/or margins (if applicable) on media products, to provide an easy way to set commercial standards for curation business. Curators can set pricing guidelines or margin requirements for certain products. For example, a curator can select a particular margin (e.g., 10%) on some products but another particular margin (e.g., 30%) on other products. User interface 800 and/or platform 700 enables operationalizing those guidelines which facilitates scaling the curation business with large customers.

As a curator or broker, a user, such as but not limited to via the user interface 800, the plan window, one or more APIs or other techniques, can generate a forecast for media products (e.g., either dynamically or for products that have already been defined) using a complex set of targeting parameters that define a media package to create packages that are commercially viable. Curators desire to understand what combination of targeting parameters is commercially viable, which may be subjective to the curator and the end buyer. Like any media seller, curators may desire to balance a buyer's desire for precise targeting with creating a scalable package that is large enough to fulfill campaign budgets. Curators, such as but not limited to via the user interface 800, one or more of the windows described herein, one or more APIs or other techniques, can experiment to figure out what product is right, or adapt to changing buyer requirements that come in over time, or are forced by budget cuts or campaign delays.

As a curator or broker, a user, such as but not limited to via the user interface 800, the plan window, one or more APIs or other techniques, can generate forecast data and information based on various parameters (including but not limited to): timeframe; geography: country, region (e.g., Europe), state (e.g., New York), city (e.g., Kalamazoo, Mich.), DMA (e.g., Wichita-Hutchinson, Kans.), postal code; supply type (e.g., Web vs. App); device type (e.g., desktop/tablet/phone/CTV); segment (e.g., the curator's IP datasets and/or 3P datasets)—with complex boolean logic; video parameters: position (e.g., instream v. outstream), context (e.g., pre-roll, mid-roll), player size; viewability threshold; video completion rate threshold; ads.txt compliant (e.g., adopted and posted); priority (e.g., runs above open auction)—this can require a product solution/publisher deals; fee transparent (yes/no); sellers (e.g., Turner); seller deals assigned to the curator's seat; domain/app list (e.g., NYTimes.com); system parameters: browser, OS, language, device model, carrier. As a curator or broker, a user, such as but not limited to via the user interface 800, the plan window, one or more APIs or other techniques, can understand the forecast according to various metrics (e.g., impressions, user reach). User interface 800 and/or platform 700 enable forecasts to be executed in short periods of time such as seconds.

As a curator or broker, a user, such as but not limited to via the user interface 800, the plan window, one or more APIs or other techniques, can export a report for any forecast that lists domains/apps that qualify for targeting of the user to provide a method so that the user can communicate to a buyer where they are likely to deliver if they buy the deal. Site lists may be one of the primary ways buyers try to objectively understand what they are buying when they buy an aggregated bundle of supply. As a curator or broker, a user, such as but not limited to via the user interface 800, the plan window, one or more APIs or other techniques, can obtain information that allows the user to respond to buyer questions like this and effectively market their curated media packages. As a curator or broker, a user, such as but not limited to via the user interface 800, the plan window, one or more APIs or other techniques, can save a dynamic forecast as a media product so the user does not need to re-configure a product in a different UI.

As a curator or broker, a user, such as but not limited to via the user interface 800, the plan window, one or more APIs or other techniques, can generate a clearing price estimate for an inventory forecast so the user knows how to tell a buyer how much they should bid as a prediction to win inventory. The user interface 800 and/or the platform 700 enable a user to estimate prices that should be bid in order to win an auction on a deal. Buyers need to know how much to bid to ensure their campaign can deliver when buying a curated deal, and curators need to know where they should set a floor if they decide to set one, or how their margin will change the required bid price, if they decide to set one. As a curator or broker, a user, such as but not limited to via the user interface 800, the plan window, one or more APIs or other techniques, can see a range of bid prices in some way—e.g., via a box plot, quartiles, deciles, and so forth. If the curator has access to margin features, they can add target margin requirements such as based on either a fixed CPM basis or percentage of buyer media cost basis and see how that impacts pricing. As a curator or broker, a user, such as but not limited to via the user interface 800, the plan window, one or more APIs or other techniques, can see broad pricing benchmarks on the platform 700 so that the user knows if their packages are efficient or expensive relative to the broader supply in the market (e.g., that a buyer would be utilizing for comparison).

As a curator or broker, a user, such as but not limited to via the user interface 800, the plan window, one or more APIs or other techniques, can access information as to what kind of premium/discount their packages have relative to the market that buyers participate in. As a curator or broker, a user, such as but not limited to via the user interface 800, the plan window, one or more APIs or other techniques, can see the current average clearing prices for various factors such as (but not limited to): timeframe; format (e.g., display/video); supply type (e.g., web vs. app); device type (e.g., desktop/tablet/phone/CTV); video context (e.g., pre-roll, mid-roll). In one or more embodiments, benchmarks can be made available by country with a filter.

In one or more embodiments, functions can be provided for packaging individual curated deals for buyers to purchase and execute with contributing inventory, data, pricing, etc., which enable the broker or curator to support or engage in campaign management activities. These functions can be provided in a number of different ways such as through the user interface 800 (e.g., the package window (the link 810 thereto is shown in FIG. 8)), through one or more APIs, and/or through other techniques. For example, a broker or curator, such as but not limited to via the user interface 800, the package window, one or more APIs or other techniques, can create and edit deals, apply relevant targeting, apply relevant pricing or margin, and/or assign deals to buyers. In one or more embodiments, a broker or curator, such as but not limited to via the user interface 800, the package window, one or more APIs or other techniques, can create or otherwise populate various fields that results in generating line items and various types of deals.

As a curator or broker, a user, such as but not limited to via the user interface 800, the package window, one or more APIs or other techniques, can bundle supply in a sophisticated way from an advertiser exchange (e.g., an exchange managed by various entities including an entity that manages the platform 700) into a deal ID (shown in field 805) and assign it to one or many buyers on any DSP or other ad exchange platform integrated to the platform 700 to buy so that the user has a robust way to create and sell media packages that are based on curated deals between buyers and sellers. The user interface 800, the package window, one or more APIs or other techniques are provided that enable a user to fulfill curated deals and provides various information associated with deals including fields that are populated with names of advertisers 825, number of insertion orders 830, number of line items 835 which represent the curated deals a broker has created and a hierarchy in which to manage them, number of impressions 850, the buyer spend 875, the media cost 880, and other key performance indicators that allow the curator to understand activity on their curated deals and manage their business. As a curator or broker, a user, such as but not limited to via the user interface 800, the package window, one or more APIs or other techniques, can package inventory in a way that some or all DSPs currently support such that the curated deals are compatible with multiple ad exchanges or DSPs. Curators can bundle supply in a targeted way, using all of the functionality provided via forecasting as described above.

As a curator or broker, a user, such as but not limited to via the user interface 800, the package window, one or more APIs or other techniques, can name the deal in a customized way such as by using field 815 so the user has a simple way to manage campaigns that is consistent with other ad tech platforms the user utilizes, in addition to the deal ID field 805. In one embodiment, curation may be a dedicated operational function within a company, involving many people, and curators are provided such as but not limited to via the user interface 800, the package window, one or more APIs or other techniques with a way to organize their account using naming conventions, or language that is custom to their organization. As a curator or broker, a user, such as but not limited to via the user interface 800, the package window, one or more APIs or other techniques, can edit any element of a deal (including margin/floor if applicable as in field 870), even where the deal is already live so that the user does not need to re-issue deal IDs to buyers. As a curator or broker, a user, such as but not limited to via the user interface 800, the package window, one or more APIs or other techniques, can optimize or otherwise improve their deals, update targeting, update start dates/caps, update margin values, and so forth after a campaign is live based on buyer performance and feedback.

As a curator or broker, a user, such as but not limited to via the user interface 800, the package window, one or more APIs or other techniques, can take a margin on a deal, such as on a fixed CPM (shown for example in field 885) or percentage of buyer media cost basis, so the user earns money from fulfillment of the deal. In one embodiment, curators can manage their deals and the profit being pursued differently such as but not limited to via the user interface 800, the package window, one or more APIs or other techniques. For example, a first curator may want to be transparent with buyers on the profit they take on curation activity while another curator may be non-transparent and justify their fees through performance. A fixed margin can be simple for buyers to understand and can incentivize them to buy higher price inventory. A relative margin makes it easier for curators to earn more profit on higher price inventory and operate more like a technology platform would. In one or more embodiments, not all curators will have an ability to take a margin, which can be implemented via an administrative control (e.g., such as but not limited to via the user interface 800, an admin window, one or more APIs or other techniques). As a curator or broker, a user, such as but not limited to via the user interface 800, the package window, one or more APIs or other techniques, can limit how much a buyer can spend against a curated deal ID such as per day, per week, per month and/or per lifetime so that the user can manage the finite amount of media credits the user has with a given seller. For example, field 820 indicates the time period for the data that is to be shown in the package window of the user interface 800.

In one or more embodiments, curators such as but not limited to via the user interface 800, the package window, one or more APIs or other techniques, can limit how much a buyer can spend against a given deal ID in order to manage spend agreements they have with individual sellers which cannot exceed a media credit limit they have with a specific seller. As a curator or broker, a user, such as but not limited to via the user interface 800, the package window, one or more APIs or other techniques, can add notes and custom labels to deals so the user has a way to add database keys on report exports that help the user join or otherwise merge data (e.g., supplied by other sources including the platform manager) with data from the user's business intelligence system, or add and store meaningful context to deals for the user's operations team to reference later. Like any media seller, curators may track or organize their account in arbitrary ways, for example by sales team structure. Or, they may need to track a particular salesperson, or trafficker, or add a note on why a deal was setup with a pricing or margin exception and so forth. Therefore, the user interface 800, the package window, one or more APIs or other techniques are provided that enable users to populate arbitrary label and note fields on every object in their account so that particular tracking and organizing techniques can be implemented by the user.

In one or more embodiments, functions are provided for managing active curated deals to monitor performance, identify issues, and tune as necessary to improve performance, which enable the broker or curator to support or engage in intra-campaign motion. These functions can be provided in a number of different ways such as through the user interface 800 the optimize window (the link 810 thereto is shown in FIG. 8)), through one or more APIs, and/or through other techniques. For example, a broker or curator, such as but not limited to via the user interface 800, the optimize window, one or more APIs or other techniques, can identify opportunities for improvement to performance, scale, and/or margin. In one or more embodiments, a broker or curator, such as but not limited to via the user interface 800, the optimize window, one or more APIs or other techniques, can access data indicating supply (e.g., publisher deals) and demand (e.g., buyer deals). In one or more embodiments, a broker or curator, such as but not limited to via the user interface 800, the optimize window, one or more APIs or other techniques, can access troubleshooting metrics, such as to provide a transaction funnel on all deals. In one or more embodiments, a broker or curator, such as but not limited to via the user interface 800, the optimize window, one or more APIs or other techniques, can access a troubleshooting tool that enables generating sample requests, obtaining suggestions or recommendations for deals and other functions that allow the broker or curator to control or otherwise manage curated deals. In one or more embodiments, a broker or curator, such as but not limited to via the user interface 800, the optimize window, one or more APIs or other techniques, can access optimization opportunities information, such as “Do X, Get Y” recommendations that are generated according to an analysis of available data. For example, curators may receive recommendations to exclude certain postal codes, seller placement IDs, or other granular targeting parameters that carry higher than average prices to increase curator margin. Or, curators may receive recommendations to include targeting of granular targeting parameters that carry higher than average historical viewability or completion rates to improve buyer performance against those targets. In one or more embodiments, a broker or curator, such as but not limited to via the user interface 800, the optimize window, one or more APIs or other techniques, can access algorithmic optimization for its curated deals, such as allowing algorithmic control to be applied to generate and manage some or all of the curated deals. For example, the algorithmic control can include estimating margins to be taken to improve or optimize fulfilling of the curated deals. In one or more embodiments, the algorithmic control can be based on models that are managed by the platform manager and/or can be models develops by the broker. In one embodiment, the platform can provide a recommendation and forecasting based on an analysis performed utilizing modeling of the platform 700 and the results can be compared (e.g., shown side-by-side or graphically overlapping each other) to a recommendation and forecasting based on an analysis performed utilizing modeling of the broker, such as a proprietary algorithm that the platform 700 can access and execute on behalf of the broker.

As a curator or broker, a user, such as but not limited to via the user interface 800, the optimize window, one or more APIs or other techniques, can opt to have the platform manager programmatically optimize the user's margin on a line item basis to maximize or improve the user's profit. The platform manager can assist curators or brokers in being more successful on the platform 700 by maximizing or improving their profit in a dynamic way through various tools and algorithms which analyze historical data being collected from deals being fulfilled. For an entity managing the platform 700 and providing the user interface 800, the various windows, the one or more APIs or other interfacing techniques, a fee can be charged when curators enable programmatic margin optimization so that the managing entity can fund data science resources to maintain and improve algorithmic features for curators. In one or more embodiments, these algorithmic features include estimating margins that can be taken by analyzing past bidding. Artificial Intelligence modeling can be applied to the past bidding (including various parameters associated with the bidding including price, advertising subject matter, client identification, bidding trends, and so forth) to facilitate estimating margins that a curator or bidder can attempt to take on a curated deal. The success or failure of the estimated margins can be further analyzed as part of the AI modeling to improve the estimated margins that are recommended to the curator or broker for each of the curated deals that are being analyzed.

As a curator or broker, a user, such as but not limited to via the user interface 800, the optimize window, one or more APIs or other techniques, can see metrics on some or all parts of the transaction funnel per deal in the user interface, so that the user has an easy way to understand if a deal is broken or is otherwise faulty and if so, where in the transaction funnel the fault exists, such as the curated deal's targeting parameters are so specific there are no impressions that meet the criteria, or that there is a large volume of eligible inventory but the buyer's DSP is not configured to receive bid requests for that inventory due to bidder profile settings, or the buyer is receiving a large volume of bid requests but is not bidding on them, or the buyer is bidding but with creative that is forbidden on seller supply due to ad quality rules, or the buyer is not bidding high enough to meet seller floor prices, or the buyer is bidding with an unregistered or expired creative, and so forth. In one embodiment, the functionality described herein such as but not limited to via the user interface 800, the optimize window, one or more APIs or other techniques enables curators or brokers to view various metrics on deals (including but not limited to): buyer, deal name, deal ID, imps matched, bid requests, bid rate, bids, imps sold, win rate on matched (e.g., imps sold/matched*100), win rate on bids (e.g., imps sold/bids*100). As a curator or broker, a user, such as but not limited to via the user interface 800, the optimize window, one or more APIs or other techniques, can see statistics on errors related to the user's deals so the user has an easy way to understand why a bid is unable to transact.

In one or more embodiments, functions are provided for reporting on the results of curation activity to track and monitor the business which enable the broker or curator to support or engage in intra-campaign/post-sale activity. These functions can be provided in a number of different ways such as through the user interface 800 (e.g., the report window (the link 810 thereto is shown in FIG. 8)), through one or more APIs, and/or through other techniques. For example, a broker or curator, such as but not limited to via the user interface 800, the report window, one or more APIs or other techniques, can visualize and report on historical activity. In one or more embodiments, a broker or curator, such as but not limited to via the user interface 800, the report window, one or more APIs or other techniques, can access a visualization tool that enables generating charts or graphical representations of various data including spend over time for many or a single curated deal, spend by seller or domain or buyer, margin over time or broken down by dimensions such as buyer/seller/domain/device: type, and so forth. Curators may visualize performance over time or by various dimensions that are also filtered in complex ways—for example, spend by DSP over time filtered to a specific holding company or a particular brand. In one or more embodiments, a broker or curator, such as but not limited to via the user interface 800, the report window, one or more APIs or other techniques, can access a reporting engine which allows for obtaining flat file exports and log level data, which can be provided in various formats. For example, a particular format for the log level data can be specified via user input into the user interface 800, the report window, one or more APIs or other techniques so that the resulting log level data can be fed directly into an algorithm being utilized by the user for further analysis of the curated deals.

As a curator or broker, a user, such as but not limited to via the user interface 800, the report window, one or more APIs or other techniques, can pull detailed reporting on who is buying the user's deals and where the spend is being allocated so that the user has transparency into sales and delivery for the user's business. In one embodiment, curators can pull a report with various dimensions (including but not limited to): any/all curator account objects that exist (e.g., advertiser/TO/line item/deal), bidder, buyer, brand, seller, seller publisher, seller placement group, seller placement, seller deal, size, country, media type, device type, site domain, mobile app, video context, member currency, billing currency. As an example, all dimensions can be made available via a report filter. In another embodiment, curators can pull a report with the following metrics: impressions, spend, margin (if applicable). In one embodiment, curators can have access to standard range/interval/timezone settings in generating the reports. In another embodiment, curators can have access to standard delivery options (e.g., UT/Export/Email/Schedule).

As a curator or broker, a user, such as but not limited to via the user interface 800, the report, window, one or more APIs or other techniques, can receive or otherwise access log level data on account activity so that the user can analyze the user's business in a detailed way and make adjustments to deals to improve performance and buyer outcomes. In one embodiment, the functions described herein, such as but not limited to via the user interface 800, one or more of the windows, one or more APIs or other techniques, enable curators (e.g., supply managers for large holding companies) to utilize their own business intelligence tools and solutions ingest log data obtained from the platform 700 into those tools. In other embodiments, other curators (e.g., a performance-oriented asset monetizer) can ingest log data on their activity to figure out how to better optimize their campaigns and campaign margin. The functions described herein, such as but not limited to via the user interface 800, one or more of the windows, one or more APIs or other techniques, allow a user to obtain batch log level data to provide granular details rather than or in addition to aggregation of data via more general reports provided via the user interface.

In one or more embodiments, functionality is provided which enables an administrator to support or engage in internal management of the curation business. These functions can be provided in a number of different ways such as through the user interface 800 (e.g., the admin window), APIs and/or through other techniques. In one embodiment, this functionality, such as via an admin window, is not a curator facing feature and/or requires special privilege or authorization to access, such as being limited to administrators of the platform managing entity.

In one or more embodiments, the user interface 800, the admin window, APIs or other techniques enable controlling and/or gating the users and the functions that they are capable of performing or otherwise accessing, such as via the user interface 800, the one or more windows, the one or more APIs or the other techniques being utilized for providing the functionality. As an administrator, a platform manager, such as via the user interface 800, the admin window, APIs or other techniques, can define which curators can and cannot take margin on a transaction so the platform manager has a way to enforce contractual requirements and strategic direction of the curator product. For example, not all curators need to take a margin on transactions, and the cost of using the platform 700 can depend in part on whether margin is a key component of the curator's business model. In one embodiment, the platform 700 can prevent curators or brokers from applying margin and becoming a margin-based broker without a contractual negotiation. As an administrator, a platform manager, such as via the user interface 800, the admin window, APIs or other techniques, can configure the level of transparency of curator fees including the ability to share platform management rates with buyers. In one embodiment, since not all curators will want their fees to be transparent, the default setting can be blind as to showing platform management rates. In another embodiment, curators (e.g., supply managers) can change that default so that they are operating in a fully transparent model as to various fees being charged.

As an administrator, a platform manager, such as via the user interface 800, the admin window, APIs or other techniques, can designate members that a specific curator is permitted to transact with so that the platform manager can control costs associated with external SSPs, prevent unauthorized supply chain intermediaries, and/or protect curators from human errors that impact their deals. The user interface 800 and/or platform 700 (e.g., via controls accessed at the admin window, APIs or other techniques) can manage or control the eligible supply including controlling entities that can interact with each other (e.g., particular buyers can be specified by the administrator for interaction and potential deals with a curator).

In one or more embodiments such as via the user interface 800, one or more of the windows. APIs or other techniques and the platform 700, the platform manager and/or certain curators can artificially restrict who a given curator seat can transact with. For example, the platform manager such as via the user interface 800, one or more of the windows, APIs or other techniques and the platform 700 can enable use of certain external SSPs (e.g., according to particular commercial terms or contractual negotiations), but not others. In one embodiment, the platform manager such as via the user interface 800, one or more of the windows, APIs or other techniques and the platform 700 can enable data providers to transact with specific external DSPs but not others, if their data is available in the data marketplace today. In one or more embodiments, the user interface 800, one or more of the windows, APIs or other techniques and the platform 700 provides that some curators (e.g., barter agencies) can only be able to monetize media credits if they transact with specific seller members. This can also facilitate providing to the curators or brokers technical protections against human errors that include selecting or otherwise interacting with the wrong sellers. In one embodiment, users (e.g., holding companies) can request that the platform manager ensures supply strategy teams can only sell to particular buyers associated with the user (e.g., owned by the holding company), which can be implemented through use of the user interface 800, one or more of the windows, APIs or other techniques and platform 700. In one embodiment, the platform manager, such as via the user interface 800, the admin window, APIs or other techniques, can blacklist buyer/seller member IDs on a curator ID basis. For example, a member trying to transact with a curator where that member has been blacklisted can generate or otherwise cause a unique error during the auction.

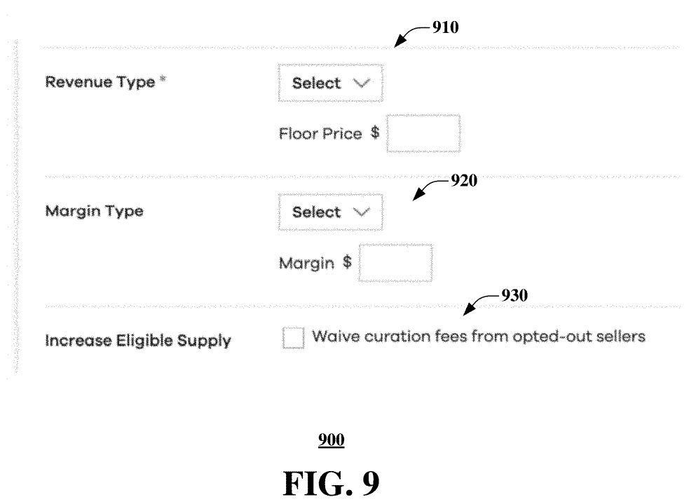

Referring now to FIG. 9, an example, non-limiting embodiment of a portion of a user interface 900 that can be utilized with system 700 (or other embodiments that facilitate managing curated deals) is shown in accordance with various aspects described herein to provide for broker or curated deals in electronic advertising. The user interface 900 can be used in conjunction with user interface 800 (e.g., as a separate window or appearing in one of the windows described above) or can be utilized as a separate user interface. Various devices and combinations thereof can be utilized to generate the user interface 900 that facilitates implementing curated deals in electronic advertising including employing one or more of the functions of data flow 200 of FIG. 2A, the components and methodology of FIG. 2B and/or combining with various systems described herein such as system 100 of FIG. 1. User interface 900 enables management, by a broker or curator, of deals in electronic advertising in a number of different ways which can include inputting information that generates curated deals where brokers aggregate inventory for multiple sellers and offer the curated deals to one or more buyers. Other techniques can also be utilized for providing the functionality described with respect to user interface 900 including via APIs or other user interfaces that are configured in other ways.

In one embodiment, the user interface 900 can include a selection 910 for a type of revenue sought along with a floor price. As an example, the revenue type 910 can be a floor setting, such as Standard CPM which means “don't sell unless a buyer bids above X, but charge them X exactly even if they bid more” and/or Dynamic CPM which means “don't sell unless a buyer bids above X, but charge them whatever they bid.” In one embodiment, once Dynamic CPM is selected, a dropdown menu appears, allowing the user to also select Market Price.

In one embodiment, the user interface 900 can include a selection 920 for a type of margin sought along with a margin value. As an example, the margin type 920 can be how the curator wants their profit calculated, such as Percentage which means “take X % of the buyer's bid as my profit”—this makes profit a function of the buyer's bid—the more the buyer bids, the more profit the curator makes. The margin type 920 can also be CPM which means “take $X.XX of the buyer's bid as my profit”—this makes profit independent of the buyer's bid—whatever the buyer bids, the curator makes X exactly.

In one embodiment, the user interface 900 can include a selection 930 for waiving the curation fees from opted-out sellers. When enabled, the curated deal can curate from sellers who do not allow deductions to be taken. The deductions will not be taken, but the supply will be taken.

In one or more embodiments, user interface 900 and platform 700 enables scaling out curation offering to 3rd party use cases by equipping clients with not only the tools to earn revenue from curation, but also to do so on a deal-by-deal basis.

In one or more embodiments, curators can set a margin on curated deals which can include specifying a percentage or CPM value for the profit they would like to take on the deal. For example, a broker who layers valuable data over a curated deal, can determine that a 15% margin is acceptable to account for the value they are providing the buyer.

As another example, curators can set a floor on curated deals. In order to effectively allow curators to set a margin, they can specify the floor of their deal. Deal floors can be set without margins and they can be any of the deal line item options (e.g., Standard, Fixed, Market). Floors on curated deals can give buyers more guidance on how to bid, which may result in buyers bidding more accurately once they have a floor and/or buyers bidding more on impressions that come with a deal floor.

Seller's contract settings can be reflected directly in an API and respected at the time of auction so that managing seller contract agreements is no longer an entirely manual process. The platform 700 allows for dentification of sellers that allow curation deductions to be taken during the auction. A deduction can be any slice of the transaction taken out by the curator. The platform 700 allows curators to include supply that does not allow deductions. This feature allows internal curation seats to curate supply from sellers who do not allow deductions. For instance, a curator can decide to include supply that bans deductions and opt not to take margin or fees. This can allow internal curator seats to include more supply for the sake of scale without breaking publisher agreements.

In one or more embodiments, the floor the curator sets can be at their discretion which means that a curator could set a floor that is below seller floors. Curators can also choose to set floors that are above all seller floors to ensure buyers always clear. On the other hand, curators can choose to set floors that match the lowest seller floor, indicating the lowest possible value a buyer should bid to clear some of the time.

In one or more embodiments, a buyer bid is taken at face value, margin is deducted (as well as fees), and the remaining revenue can be provided to the seller. In one embodiment, the formula for any markdown can be markdown amount=bid*(1-rate). The order in which this happens can be: buyer bid gets buyer fees removed; from that value, margin and broker auction service charge are taken; then, impression seller and seller-associated fees can be taken out of the remaining amount.

In one or more embodiments, when a seller deal is a fixed price and the curated deal is fixed/standard price and no margin has been set, the platform 700 causes the deal to throw an error because there is no-where for the extra money to go. In one or more embodiments, when the seller deal is a fixed price and curator floor is fixed price, but with a margin, the curator can be provided the difference between the two floors, regardless of what the margin is that is set on the curated deal (assuming the minimum margin does not make the curator floor lower than the seller floor which would cause a rejection of the transaction). Because the publisher has set the exact price they want to be paid and so has the curator, the difference between these two floors can be provided to the curator. In one or more embodiments, when the seller deal is a fixed price and the curator floor is standard price and there is a margin, the curator can be provided the difference between the buyer bid and the seller fixed price (assuming the auction is first price).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor, a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
providing, by a processing system, a user interface presented at a communication device of a broker for managing curated deals in electronic advertising;
obtaining, by the processing system via the user interface, user input comprising targeting data, margin data, and assigned buyers;
generating, by the processing system, a curated deal based on the user input, wherein the curated deal is assigned to the assigned buyers;
storing, by the processing system, the curated deal;
receiving, by the processing system, an ad call associated with an ad space available in media content that is being presented at an end user device;
conducting auctions with a group of bidders, wherein the auctions include a curated deal auction based on the curated deal in which the broker aggregates curated deal inventory across a plurality of sellers including a seller of the ad space, and wherein the curated deal inventory includes the ad space;
obtaining bids from the auctions;
determining a winning bid from among the bids; and
providing a notification associated with the winning bid, wherein the notification causes the end user device to render a creative associated with the winning bid in the ad space.

2. The method of claim 1, further comprising:
obtaining, by the processing system via the user interface, second user input comprising pricing data, other targeting data, and other margin data;
generating, by the processing system, multiple curated deals based on combinations of prices, targets and margins derived from the pricing data, other targeting data, and other margin data, respectively;
storing, by the processing system, the multiple curated deals.

3. The method of claim 1, wherein the curated deal has a format compatible with multiple ad exchange platforms.

4. The method of claim 1, wherein the user interface identifies one or more advertisers, a number of line items and a number of campaigns corresponding to a deal identification of the curated deal.

5. The method of claim 1, wherein the user interface identifies buyer spend and media cost corresponding to a deal identification of the curated deal.

6. The method of claim 1, further comprising:
obtaining, by the processing system via the user interface, second user input comprising a margin data change corresponding to the curated deal;
adjusting, by the processing system, the curated deal based on the second user input to generate an adjusted curated deal with an adjusted margin without reissuing other deal identifications to the assigned buyers;
receiving, by the processing system, a second ad call associated with a second ad space available in second media content that is being presented at a second end user device;
conducting second auctions with a second group of bidders, wherein the second auctions include a second curated deal auction based on the adjusted curated deal in which the broker aggregates the curated deal inventory across the plurality of sellers including a second seller of the second ad space, and wherein the curated deal inventory includes the second ad space;
obtaining second bids from the second auctions;
determining a second winning bid from among the second bids; and
providing a second notification associated with the second winning bid, wherein the second notification causes the second end user device to render a second creative associated with the second winning bid in the second ad space.

7. The method of claim 1, further comprising:
receiving, by the processing system via the user interface, a request for forecast information;
generating, by the processing system, the forecast information according to parameters associated with the curated deal and monitoring of an ad exchange; and
presenting, by the processing system via the user interface, the forecast information.

8. The method of claim 7, wherein the forecast information comprises predicted viewability rate, predicted video completion rate, or a combination thereof.

9. The method of claim 7, wherein the user interface includes an admin window that enables generating a limit list as to buyers that the broker can transact with.

10. The method of claim 7, wherein the parameters associated with the curated deal comprise a price, a margin or a combination thereof, and wherein the monitoring of the ad exchange comprises determining information corresponding to successful ad space purchases.

11. The method of claim 10, wherein the information corresponding to the successful ad space purchases comprises a winning bid of a buyer that is not associated with any curated deals of the broker.

12. The method of claim 1, wherein the conducting the auctions with the group of bidders includes providing at least some of the group of bidders with viewer data collected by the broker.

13. The method of claim 12, wherein the broker is an e-commerce entity managing an e-commerce website, and wherein the viewer data comprises a purchasing history, a browsing history or a combination thereof for a viewer of the end user device.

14. A device, comprising:
a processing system including a processor; and
a memory that stores executable instructions that, when executed by the processing system, facilitate performance of operations, the operations comprising:
providing a user interface presented at a communication device of a broker for managing curated deals in electronic advertising;
obtaining, via the user interface, first user input comprising targeting data and assigned buyers;
generating a curated deal based on the user input, wherein the curated deal is assigned to the assigned buyers;
storing the curated deal to be analyzed during a campaign of the curated deal to enable determinations as to whether the curated deal is fulfilled;
obtaining, via the user interface while the campaign is in progress, second user input comprising a parameter change corresponding to the curated deal;
adjusting, while the campaign is in progress, the curated deal based on the second user input to generate an adjusted curated deal without reissuing other deal identifications to the assigned buyers; and
storing the curated deal to be analyzed during the campaign that is in progress to enable other determinations as to whether the curated deal is fulfilled.

15. The device of claim 14, wherein the operations further comprise:
receiving, via the user interface, a request for forecast information;
generating the forecast information according to parameters associated with the curated deal and monitoring of an ad exchange; and
presenting, via the user interface, the forecast information.

16. The device of claim 15, wherein the forecast information includes a recommended bid that is estimated to fulfill the curated deal, wherein the recommended bid is determined according to analysis of a bid history associated with multiple buyers.

17. The device of claim 15, wherein the first user input comprises margin data, and wherein the forecast information includes a recommended margin to be utilized in the curated deal.

18. A method, comprising:
obtaining, by a processing system, user input comprising pricing data, targeting data, margin data, and assigned buyers;
generating, by the processing system, multiple curated deals based on combinations of prices, targets and margins derived from the pricing data, other targeting data, and other margin data, respectively; and
storing, by the processing system, the multiple curated deals to be analyzed during campaigns of the multiple curated deals to enable determinations as to whether any of the multiple curated deals are fulfilled.

19. The method of claim 18, further comprising providing, by the processing system, a user interface presented at a communication device of a broker for managing curated deals in electronic advertising, wherein the user interface includes an admin window that enables authorizing the user to obtain margin on one or more of the multiple curated deals, and wherein the processing system automatically, and not based on user input defining a margin adjustment, adjusts a line item of the one or more of the multiple curated deals according to an analysis of successful ad space purchase information that is obtained by monitoring of an ad exchange.

20. The method of claim 18, further comprising:
obtaining, by the processing system, other user input indicating a buyer spending limit; and
limiting, by the processing system, an amount a buyer spends on a particular curated deal of the multiple curated deals according to the buyer spending limit.
